(19) United States
(12) Patent Application Publication
(10) Pub. No.: US 2024/0225017 A9
(43) Pub. Date: Jul. 11, 2024

(54) CARRIER AND FILLER FOOD COMPOSITIONS WITH HIGH PROTEIN AND LOW LIPID CONTENT

(71) Applicant: Cella Farms Inc., San Ramon, CA (US)

(72) Inventors: Baljit GHOTRA, San Ramon, CA (US); Monica BHATIA, San Ramon, CA (US)

(21) Appl. No.: 18/383,630

(22) Filed: Oct. 25, 2023

Related U.S. Application Data
(60) Provisional application No. 63/419,237, filed on Oct. 25, 2022.

(51) Int. Cl. A21D 13/064; A21D 2/26; A21D 13/32; A21D 13/38

(52) U.S. Cl. CPC A21D 13/064; A21D 2/267; A21D 13/32; A21D 13/38

(57) ABSTRACT

Provided are methods and compositions for high protein carrier:filler food products derived from fermented biomass and microbially derived proteins.

### CROSS-REFERENCE TO RELATED APPLICATIONS

This application claims benefit of priority to U.S. Provisional Patent Application No. 63/419,237, filed Oct. 25, 2022, the disclosure of which is incorporated herein by reference in its entirety for all purposes.

### FIELD

The field of this disclosure is directed to high protein carrier:filler food compositions. In certain aspects, the disclosure provides compositions of high protein carrier food products comprising fermented plant biomass and microbial derived proteins. The disclosure further provides compositions and methods to increase the protein nutritional quality score of a food composition while maintaining traditional food forms.

### BACKGROUND

Dietary protein is an essential nutrient for human health and growth. The World Health Organization (WHO) recommends that dietary protein should contribute approximately 10 to 15% of energy intake when in energy balance and weight stable. Average daily protein intakes in various countries indicate that these recommendations are consistent with the amount of protein being consumed worldwide. Meals with an average of 20 to 30% of energy from protein are representative of high-protein diets when consumed in energy balance.

The human body cannot synthesize certain amino acids that are necessary for health and growth, and instead must obtain them from food. These amino acids, called “essential amino acids” (EAA), are Histidine (H), Isoleucine (I), Leucine (L), Lysine (K), Methionine (M), Phenylalanine (F), Threonine (T), Tryptophan (W), and Valine (V). Other categories of amino acids are called as “non-essential amino acid” (NEAA) and “conditionally essential amino acid” (CEAA). A NEAA is an amino acid selected from Alanine (A), Arginine (R), Asparagine (N), Aspartic Acid (D), Glutamine (Q), Glutamic Acid (E), Glycine (G), Proline (P), and Serine (S). A CEAA is an amino acid selected from Cysteine (C) and Tyrosine (Y).

The minimum fractions of each essential amino acid that make up a healthy adult diet provide a metric against which dietary protein sources can be measured. For example, the fractions can be used to measure how well a dietary protein source meets the nutritional protein needs of humans, by targeting nutritionally balanced amino acid percentages. The World Health Organization (WHO) has developed a method for ranking the nutritional quality of a protein that compares the amino acid profile of the specific food protein against the amino acid requirements for human health. This method assigns a nutritional value to the protein called the “Protein Digestibility Corrected Amino Acid Score” (PDCAAS). An alternative standard has also been developed, the “Digestible Indispensable Amino Acid Score (DIAAS)”.

Dietary proteins that provide all the essential amino acids are referred to as “high quality” proteins. Animal foods such as meat, fish, poultry, eggs, and dairy products are generally regarded as high quality protein sources that provide a good balance of essential amino acids. The current methods to produce high quality protein, as found in animal food, generally involve a high carbon footprint, large land use, and significant consumption of water resources.

In contrast, foods that do not provide a good balance of essential amino acids are referred to as “low quality” proteins. Most fruits and vegetables are poor sources of protein and generally require less resources to produce compared to animal foods. While some plant foods, including beans, peas, lentils, nuts and grains (such as wheat) are better sources of protein, many of these foods are high in carbohydrates.

The use of new high-protein food sources can greatly increase access to nutritious food sources and could help to improve a variety of health outcomes for the population (Rul et al, “Underlying evidence for the health benefits of fermented foods in Humans”, Food Funct. Vol 13, 2022). Yeast protein can improve muscle amelioration (Liao et al, “Muscle amelioration by yeast protein supplementation was associated with gut microbiota”, Journal of Functional Foods, February 2022).

Much of the world's population receives caloric intake through food products that are rich in carbohydrates and low in protein, such as breads, rice, sandwiches, pitas, pizzas, pastas, doughs, desserts, and processed foods. Much of these foods are traditional and culturally important. Consequently, a gap exists to provide high quality protein in a way that does not consume significant resources and maintains traditional food forms.

Generic carrier:filler food compositions are commonly designed with one or two carriers, such as a slice of bread, and typically include a filler that may be sweet or savory. Sweet or savory fillers include, but are not limited to, fruit fillers, meat fillers, meatless fillers, vegetables fillers, vegetable patty fillers, and/or cutlet fillers. Additional examples of generic carrier:filler food compositions are packaged foods. Packaged foods also include a carrier and a sweet or savory filler. Fillers for packaged foods include, but are not limited to, fruit fillers, meat fillers, meatless fillers, cheese fillers, vegan fillers, and/or vegetable fillers. Examples of packaged foods include, but are not limited to, “Pop Tarts”, “Uncrustables”, “Bagel Bites” and “Tortino's Pizza Roll”. These options only deliver less than 20% of calories coming from protein and most of the protein is in filler rather than in carrier.

While several attempts have been proposed to better fortify food with high-quality protein, all fall short of providing high-quality protein in the carrier to augment nutrition intake. For example, US20040208962A1 discloses a high protein peanut butter and jelly sandwich. This requires two slices of crustless baked bread, with protein in the filler. CA2522212A1 discloses high protein bakery products of only 12 to 16% by weight, with reduced moisture for freezing, but the percentage of protein (12 to 16%) is not complete protein.

The current disclosure solve a long-held need to provide high-quality protein in an easily consumable food-product, such as, for example, a sandwich.

### SUMMARY

In one aspect, provided herein is a food composition comprising a carrier and a filler. In some cases, the amount of total protein provided by the carrier in the food composition is greater than or equal to the amount of total protein provided by the filler. In some cases, the carrier and filler are present in the food composition at a carrier:filler protein ratio between 1:1 to 1:0. In some cases, the composition comprises greater than 20% of total calories from protein per serving. In some cases, the composition comprises greater than 25% of total calories from protein per serving. In some cases, the carrier comprises microbially produced or microbial protein. In some cases, the carrier comprises a plant-based or plant-produced protein. In some cases, the carrier comprises a mixture of microbially produced protein and a plant-based protein. In some cases, the carrier comprises at least 15% total protein by weight of microbially produced protein. In some cases, the plant-based protein is selected from the group consisting of a flour, a gluten, a plant-protein that is not a gluten or flour and any combination thereof. In some cases, the microbially produced protein is obtained by fermentation of a biomass by a microbe. In some cases, the biomass is a plant biomass. In some cases, the plant biomass is selected from the group consisting of a food crop, an extract of a food crop, seaweed, plankton, phytoplankton, grass crops, agricultural crop waste and residues, spent grain from ethanol production, or spent grain from breweries, spent yeast or microbial biomass from fermented products manufacturing facilities, trees, woody energy crops and wood waste and residue. In some cases, the food crop is selected from the group consisting of sugarcane, wheat, tubers, vegetables, lentils, kelp, legumes, soybeans, rice, potato, oats, pea, cassava and maize. In some cases, the microbe is selected from the group consisting of a fungus, a bacterium, an archaea, a protist and any combination thereof. In some cases, the microbe is a fungus selected from the group consisting of a yeast or filamentous fungus. In some cases, the yeast is a Pichia species or Saccharomyces species. In some cases, the yeast is Saccharomyces cerevisiae. In some cases, the filamentous fungus is a species of filamentous fungus selected from the group consisting of Aspergillus, Fusarium, Rhizopus or Mucor. In some cases, the filamentous fungus is Aspergillus niger. In some cases, the microbe is a species of bacterium selected from the group consisting of Lactobacillus, Bacillus, Bifidobacterium, Clostridium, Enterococcus, Corynebacterium and any combination thereof. In some cases, the bacterium is Corynebacterium glutamicum. In some cases, the bacterium is Clostridium acetobutylicum. In some cases, the composition comprises between 20% to 51% of calories from protein and between 50 calories to 640 calories per serving. In some cases, the composition comprises a minimum of 20% of calories coming from protein and between 120 calories to 640 calories per serving. In some cases, the composition comprises a maximum of 51% of calories coming from protein and between 120 calories to 640 calories per serving. In some cases, the composition comprises at least 40% to 220% more calories from protein compared to a generic composition. In some cases, the composition comprises 20% to 70% fewer calories from carbohydrates compared to a generic composition. In some cases, the composition comprises similar calories from fat while maintaining higher protein compared to a generic composition. In some cases, the PDCAAS of the carrier is a value selected from the group consisting of at least 0.8, at least 0.9 and at least 1.0. In some cases, the carrier is a high-quality source of proteins for a subject. In some cases, the carrier provides a plurality of the essential amino acids (EAAs) for a subject. In some cases, the carrier provides at least 20%, at least 40%, at least 60% or at least 80% of the essential amino acids (EAAs) for a subject. In some cases, the carrier provides all of the essential amino acids (EAAs) for a subject. In some cases, the subject is a human subject. In some cases, the subject is a human, and the plurality is 4, 5, 6, 7, 8 or 9 of the essential amino acids. In some cases, the carrier comprises an amino acid distribution profile of between 20% to 50% branched chain amino acids (BCAAs). In some cases, the moisture content of the composition is between 2-80%. In some cases, the carrier is made from a protein powder with a hydration capacity similar to commercially available flour. In some cases, the carrier is made from a protein powder that comprises a water hydration capacity (WHC) of from 80 to 150 grams (g) of water per 100 g of protein powder. In some cases, the carrier is made from a protein powder that comprises a water hydration capacity (WHC) of at least 80 g of water per 100 g of protein powder. In some cases, the carrier is made from a protein powder that comprises a WHC of at least 85 g of water per 100 g of protein powder. In some cases, the carrier is made from a protein powder that comprises a WHC of between 80 g-85 g of water per 100 g of protein powder. In some cases, the carrier is made from a protein powder that comprises a Solvent Retention Capacity (SRC) of at least 60%, at least 70%, at least 80%, at least 90% or at least 100%. In some cases, the carrier for use in the food composition comprises organoleptic properties that are the same or substantially similar to organoleptic properties of any commercially available carrier. In some cases, the caloric content of the composition is selected from the group consisting of less than 640 calories per serving, less than 500 calories per serving, and less than 400 calories per serving. In some cases, the filler is not an animal product. In some cases, the filler is selected from the group consisting of a vegan filler, a plant-based product, an animal product, both an animal product and a plant-based product, a water-in-oil based emulsion and an oil-in-water emulsion. In some cases, the plant-based product is selected from the group consisting of a vegetable, a fruit, a veggie patty and any combination thereof. In some cases, the vegetable is a potato. In some cases, the fruit is an avocado or cucumber. In some cases, the animal product is a hamburger or a cheese. In some cases, the composition comprises at least one slice. In some cases, the carrier has a thickness selected from the group consisting of at least 0.1 centimeter, at least 1 centimeter, at least 2 centimeters and at least 3 centimeters. In some cases, the carrier comprises a single slice of bread. In some cases, the carrier comprises two slices of bread. In some cases, the carrier comprises a single slice of cracker. In some cases, the carrier comprises two slices of cracker. In some cases, the carrier comprises a single slice of sheeted dough. In some cases, the carrier comprises two slices of sheeted dough.

In another aspect, provided herein is a carrier;filler food composition that comprises (a) a carrier:filler protein ratio between 1:1 to 1:0; (b) greater than 20% of total calories from protein per serving; and (c) less than 640 total calories per serving. In some cases, the carrier comprises microbially produced or microbial protein. In some cases, the carrier comprises a plant-based or plant-produced protein. In some cases, the carrier comprises a mixture of microbially produced protein and a plant-based protein. In some cases, the carrier comprises at least 15% total protein by weight of microbially produced protein. In some cases, the plant-based protein is selected from the group consisting of a flour, a gluten, a plant-protein that is not a gluten or flour and any combination thereof. In some cases, the microbially produced protein is obtained by fermentation of a biomass by a microbe. In some cases, the biomass is a plant biomass. In some cases, the plant biomass is selected from the group consisting of a food crop, an extract of a food crop, seaweed, plankton, phytoplankton, grass crops, agricultural crop waste and residues, spent grain from ethanol production, or spent grain from breweries, spent yeast or microbial biomass from fermented products manufacturing facilities, trees, woody energy crops and wood waste and residue. In some cases, the food crop is selected from the group consisting of sugarcane, wheat, tubers, vegetables, lentils, kelp, legumes, soybeans, rice, potato, oats, pea, cassava and maize. In some cases, the microbe is selected from the group consisting of a fungus, a bacterium, an archaea, a protist and any combination thereof. In some cases, the microbe is a fungus selected from the group consisting of a yeast or filamentous fungus. In some cases, the yeast is a Pichia species or Saccharomyces species. In some cases, the yeast is Saccharomyces cerevisiae. In some cases, the filamentous fungus is a species of filamentous fungus selected from the group consisting of Aspergillus, Fusarium, Rhizopus or Mucor. In some cases, the filamentous fungus is Aspergillus niger. In some cases, the microbe is a species of bacterium selected from the group consisting of Lactobacillus, Bacillus, Bifidobacterium, Clostridium, Enterococcus, Corynebacterium and any combination thereof. In some cases, the bacterium is Corynebacterium glutamicum. In some cases, the bacterium is Clostridium acetobutylicum. In some cases, the composition comprises between 20% to 51% of calories from protein and between 50 calories to 640 calories per serving. In some cases, the composition comprises a minimum of 20% of calories coming from protein and between 120 calories to 640 calories per serving. In some cases, the composition comprises a maximum of 51% of calories coming from protein and between 120 calories to 640 calories per serving. In some cases, the composition comprises at least 40% to 220% more calories from protein compared to a generic composition. In some cases, the composition comprises 20% to 70% fewer calories from carbohydrates compared to a generic composition. In some cases, the composition comprises similar calories from fat while maintaining higher protein compared to a generic composition. In some cases, the PDCAAS of the carrier is a value selected from the group consisting of at least 0.8, at least 0.9, and at least 1.0. In some cases, the carrier is a high-quality source of proteins for a subject. In some cases, the carrier provides a plurality of the essential amino acids (EAAs) for a subject. In some cases, the carrier provides at least 20%, at least 40%, at least 60% or at least 80% of the essential amino acids (EAAs) for a subject. In some cases, the carrier provides all of the essential amino acids (EAAs) for a subject. In some cases, the subject is a human subject. In some cases, the subject is a human, and the plurality is 4, 5, 6, 7, 8 or 9 of the essential amino acids. In some cases, the carrier comprises an amino acid distribution profile of between 20% to 50% branched chain amino acids (BCAAs). In some cases, the moisture content is between 2-80%. In some cases, the carrier is made from a protein powder with a hydration capacity similar to commercially available flour. In some cases, the carrier is made from a protein powder that comprises a water hydration capacity (WHC) of from 80 to 150 grams (g) of water per 100 g of protein powder. In some cases, the carrier is made from a protein powder that comprises a water hydration capacity (WHC) of at least 80 g of water per 100 g of protein powder. In some cases, the carrier is made from a protein powder that comprises a WHC of at least 85 g of water per 100 g of protein powder. In some cases, the carrier is made from a protein powder that comprises a WHC of between 80 g-85 g of water per 100 g of protein powder. In some cases, the carrier is made from a protein powder that comprises a Solvent Retention Capacity (SRC) of at least 60%, at least 70%, at least 80%, at least 90% or at least 100%. In some cases, the carrier for use in the food composition comprises organoleptic properties that are the same or substantially similar to organoleptic properties of any commercially available carrier. In some cases, the calorie content of the composition is selected from the group consisting of less than 640 calories per serving, less than 500 calories per serving, and less than 400 calories per serving.

In yet another embodiment, provided herein is a method for producing a food composition comprising a carrier and a filler. In some cases, the method for producing the food composition comprises: (a) providing a high-protein powder, a comestible, and a liquid; (b) mixing the high-protein powder, comestible, and liquid into a homogeneous composition; (c) leavening the composition; (d) baking or cooking the homogeneous composition to produce a carrier; and (e) disposing a filler with the carrier to generate a carrier;filler food composition. In some cases, the amount of total protein provided by the carrier in the carrier:filler food composition is greater than or equal to the amount of total protein provided by the filler. In some cases, the carrier:filler food composition comprises greater than 20% of total calories from protein per serving. In some cases, the carrier:filler food composition comprises less than 640 total calories per serving. In some cases, the carrier and filler are present at a carrier:filler protein ratio between 1:1 to 1:0. In some cases, the high-protein powder comprises microbially produced or microbial protein. In some cases, the high-protein powder comprises a plant-based protein. In some cases, the high-protein powder comprises a mixture of microbially produced protein and a plant-based protein. In some cases, the plant-based protein is selected from the group consisting of a flour, a gluten, a plant-protein that is not a gluten or flour and any combination thereof. In some cases, the high-protein powder comprises at least 15% total protein by weight of microbially produced protein. In some cases, the plant-based protein is selected from the group consisting of a flour, a gluten, a plant-protein that is not a gluten or flour and any combination thereof. In some cases, the microbially produced protein is obtained by fermentation of a biomass by a microbe. In some cases, the biomass is a plant biomass. In some cases, the plant biomass is selected from the group consisting of a food crop, an extract of a food crop, seaweed, plankton, phytoplankton, grass crops, agricultural crop waste and residues, spent grain from ethanol production, or spent grain from breweries, spent yeast or microbial biomass from fermented products manufacturing facilities, trees, woody energy crops and wood waste and residue. In some cases, the food crop is selected from the group consisting of sugarcane, wheat, tubers, vegetables, lentils, kelp, legumes, soybeans, rice, potato, oats, pea, cassava and maize. In some cases, the microbe is selected from the group consisting of a fungus, a bacterium, an archaea, a protist and any combination thereof. In some cases, the microbe is a fungus selected from the group consisting of a yeast or filamentous fungus. In some cases, the yeast is a Pichia species or Saccharomyces species. In some cases, the yeast is Saccharomyces cerevisiae. In some cases, the filamentous fungus is a species of filamentous fungus selected from the group consisting of Aspergillus, Fusarium, Rhizopus or Mucor. In some cases, the filamentous fungus is Aspergillus niger. In some cases, the microbe is a species of bacterium selected from the group consisting of Lactobacillus, Bacillus, Bifidobacterium, Clostridium, Enterococcus, Corynebacterium and any combination thereof. In some cases, the bacterium is Corynebacterium glutamicum. In some cases, the bacterium is Clostridium acetobutylicum. In some cases, the composition comprises between 20% to 51% of calories from protein and between 50 calories to 640 calories per serving. In some cases, the composition comprises a minimum of 25% of calories coming from protein and between 120 calories to 640 calories per serving. In some cases, the composition comprises a maximum of 51% of calories coming from protein and between 120 calories to 640 calories per serving. In some cases, the composition comprises at least 40% to 220% more calories from protein compared to a generic composition. In some cases, the composition comprises 20% to 70% fewer calories from carbohydrates compared to a generic composition. In some cases, the composition comprises similar calories from fat while maintaining higher protein compared to a generic composition. In some cases, the PDCAAS of the carrier produced by baking the homogeneous composition is a value selected from the group consisting of at least 0.8, at least 0.9, and at least 1.0. In some cases, the high-protein powder and thus the carrier is a high-quality source of proteins for a subject. In some cases, the high-protein powder and thus the carrier provides a plurality of the essential amino acids (EAAs) for a subject. In some cases, the high-protein powder and thus the carrier provides at least 20%, at least 40%, at least 60% or at least 80% of the essential amino acids (EAAs) for a subject. In some cases, the high-protein powder and thus the carrier provides all of the essential amino acids (EAAs) for a subject. In some cases, the subject is a human subject. In some cases, the subject is a human, and the plurality is 4, 5, 6, 7, 8 or 9 of the essential amino acids. In some cases, the high-protein powder and thus the carrier comprises an amino acid distribution profile of between 20% to 50% branched chain amino acids (BCAAs). In some cases, the calorie content of the carrier:filler food composition is selected from the group consisting of less than 640 calories per serving, less than 500 calories per serving, and less than 400 calories per serving. In some cases, the moisture content of the carrier:filler food composition is between 2-80%. In some cases, the high-protein powder comprises a hydration capacity similar to commercially available flour. In some cases, the high-protein powder comprises a water hydration capacity (WHC) of from 80 to 150 grams (g) of water per 100 g of protein powder. In some cases, the high-protein powder comprises a water hydration capacity (WHC) of at least 80 g of water per 100 g of protein powder. In some cases, the high-protein powder comprises a WHC of at least 85 g of water per 100 g of protein powder. In some cases, the high-protein powder comprises a WHC of between 80 g-85 g of water per 100 g of protein powder. In some cases, the high-protein powder comprises a Solvent Retention Capacity (SRC) of at least 60%, at least 70%, at least 80%, at least 90% or at least 100%. In some cases, the carrier:filler composition comprises organoleptic properties that are the same or substantially similar to organoleptic properties of any commercially available carrier. In some cases, the filler is not an animal product. In some cases, the filler is selected from the group consisting of a vegan filler, a plant-based product, an animal product, both an animal product and a plant-based product, a water-in-oil based emulsion and an oil-in-water emulsion. In some cases, the plant-based product is selected from the group consisting of a vegetable, a fruit, a veggie patty and any combination thereof. In some cases, the vegetable is a potato. In some cases, the fruit is an avocado or cucumber. In some cases, the animal product is a hamburger or a cheese. In some cases, the composition comprises at least one slice. In some cases, the carrier has a thickness of at least 0.1 centimeter. In some cases, the carrier has a thickness of at least 1 centimeter. In some cases, the carrier has a thickness of at least 2 centimeters. In some cases, the carrier has a thickness of at least 3 centimeters. In some cases, the carrier comprises a single slice of bread. In some cases, the carrier comprises two slices of bread. In some cases, the carrier comprises a single slice of cracker. In some cases, the carrier comprises two slices of cracker. In some cases, the carrier comprises a single slice of sheeted dough. In some cases, the carrier comprises two slices of sheeted dough.

### BRIEF DESCRIPTION OF THE FIGURES

FIG. 1 shows a schematic of a typical sandwich design of the present disclosure. A high-protein sandwich of the present disclosure can use microbially enriched protein bread to deliver 12-20 g of protein per serving with very low fat. The filling may be vegetables or other high taste filling.

FIG. 2 shows a table that describes exemplary Panera Bread sandwiches and their nutritional characteristics (in grams).

FIG. 3 shows a table that describes exemplary Subway sandwiches and their nutritional characteristics.

### DETAILED DESCRIPTION

### Definitions

Unless defined otherwise herein, all technical and scientific terms used herein shall have the meanings that are commonly understood by those of ordinary skill in the art to which the present disclosure belongs.

The term “microorganism” can include, but is not limited to, bacteria, viruses, fungi, algae, yeasts, protozoa, worms, spirochetes, single-celled, and multi-celled organisms that are included in classification schema as prokaryotes, eukaryotes, Archaea, and Bacteria, and those that are known to those skilled in the art.

The term “plant” can include the class of higher and lower plants including angiosperms (monocotyledonous and dicotyledonous plants), gymnosperms, ferns, and multicellular algae. It includes plants of a variety of ploidy levels, including aneuploid, polyploid, diploid, haploid and hemizygous.

The term “animal” can include the class of animal products or biproducts including dairy and dairy products (e.g., milk, cheese, etc.); egg and egg products; or any animal tissue or parts.

The term “computer” can refer to a machine comprising a processor, a memory, and an operating system, capable of interaction with a user or other computer, and shall include without limitation desktop computers, notebook computers, laptop computers, processors, servers, personal digital assistants (PDAs), tablet computers, handheld computers, and similar devices that store data.

The term “cloud” may be used as a metaphor to refer to the internet and storing information, e.g., genomic sequences, in an off-site online system that is accessible via a computing device.

The term “in silico method” can refer to a method of using of a computer or computer algorithm to model a naturally occurring or in vitro process, and in some aspects, to improve or predict a protein quality score.

The term “prokaryote” can refer to non-eukaryotic organisms belonging to the Eubacteria (e.g., Escherichia coli, Thermus thermophilus, etc.) and Archaea (e.g., Methanococcus jannaschii, Methanobacterium thermoautotrophicum, Halobacterium spp., A. fulgidus, P. firiosus, P. horikoshii, A. pernix, etc.) phylogenetic domains.

The term “eukaryote” can refer to organisms belonging to the phylogenetic domain Eucarya such as animals (e.g., mammals, insects, reptiles, birds, etc.), ciliates, plants, fungi (e.g., yeasts, etc.), flagellates, microsporidia, protists, etc.

The term “unknown organism” can refer to an organism having an unknown phenotype, an unknown genomic sequence, or lacking a scientific name. An unknown organism may be used for training, and samples of the unknown organism obtained elsewhere may be identified by the method. A system trained on an unknown organism may be used either to identify the unknown organism when it occurs in a sample, or to exclude the unknown organism. In an aspect, a plurality of unknown organisms may be used to train the system and subsequent samples may be categorized so as to select an organism from the plurality of unknown organisms. Some of the phenotypes may also be associated with known genotypes. In this manner, samples of, for example, soil, may be scanned so as to identify only those organisms of a single species, or only organisms of an unknown species of a group of unknown species.

The term “PDCAAS” can refer to a Protein Digestibility-Corrected Amino Acid Score. The traditional PDCAAS method is the one most commonly used today to estimate the protein quality of food intended for human consumption by providing a protein quality score. The PDCAAS evaluates the quality of proteins according to two criteria: the essential amino acid requirements of human beings and the digestibility of proteins.

The term “IVPDCAAS” can refer to an in vitro Protein Digestibility-Corrected Amino Acid Score. The IVPDCAAS is based on the traditional PDCAAS method and incorporates in vitro tests as a surrogate to animal measurements. In one example, the PDCAAS-4-Enz method is shown to have a high R² (0.9649) when correlated with in vivo measurements, (Tavano et al, “In vitro versus in vivo protein digestibility techniques for calculating PDCAAS (protein-digestibility corrected amino acid score) applied to chickpea fractions”, Food Research International, Vol 89, November 2016). This shows that in vivo measurements can be correlated with in vitro measurements, hence allowing in vitro measurements to be used in analyzing the accuracy of in silico analyses. The k-PDCAAS method is another method for accurate determination of in vitro PDCAAS and is used by labs such as Medallion Labs, see in vitro PDCAAS Megazyme kit protocol. U.S. Pat. No. 9,700,071B2 demonstrates that the maximum PDCAAS is 3.61.

The term “DIAAS” can refer to Digestible Indispensable Amino Acid Score and is calculated as recommended by the Food and Agriculture Organization of the United Nations using equation DIAAS (%)=100 c lowest value of the DIAA reference ratio. For example, a score of <75% is a low protein quality score, 75-99% is a good protein quality score, and >100% is an excellent protein quality score. This in vivo DIAAS is normally performed in pigs.

The term “IVDIAAS” can refer to an in vitro Digestible Indispensable Amino Acid Score. The IVDIAAS is based on the traditional DIAAS method and incorporates in vitro tests as a surrogate to animal measurements. In vitro DIAAS is performed via a simulated enzymatic digestion procedure and can be provided by labs such as Wageningen Food Research labs.

The term “Amino Acid Profile” can refer to the total protein, total nitrogen content, and percent of amino acids present in the sample. The measurement of total protein and nitrogen can be performed using the Dumas method preferably, or alternatively the Kjeldahl method.

The term “comestible” can refer to any article of food or an edible composition. For example, a comestible may comprise flour, starch or dough.

The term “liquid” can refer to any composition that may hydrate a flour, starch or dough. For example, a liquid may comprise water, oil, or fat, or any combination thereof. Further examples of liquids include, but are not limited to, milk, fruit juices, and/or eggs.

The term “high-protein” as used in reference to any comestible, ingredient or powder as provided herein can refer to any comestible, ingredient or powder as provided herein that comprises 5, 6, 7, 8, 9, 10, 11, 12, 13, 14, 15, 16, 17, 18, 19, 20, 21, 22, 23, 24, 25, 26, 27, 28, 29 or 30 grams (g) of protein per serving. In some cases, the serving is 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g). The term “high-protein” as used in reference to any comestible, ingredient or powder as provided herein can also refer to any comestible, ingredient or powder as provided herein that comprises at least 5%, 6%, 7%, 8%, 9%, 10%, 11%, 12%, 13%, 14%, 15%, 16%, 17%, 18%, 19%, 20% 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99% or 100% of protein by weight per serving. The term “high-protein” as used in reference to any comestible, ingredient or powder as provided herein can also refer to any comestible, ingredient or powder as provided herein that comprises at most 5%, 6%, 7%, 8%, 9%, 10%, 11%, 12%, 13%, 14%, 1%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99% or 100% of protein by weight per serving. The term “high-protein” as used in reference to any comestible, ingredient or powder as provided herein can also refer to any comestible, ingredient or powder as provided herein that comprises about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99% or 100% of protein by weight per serving.

The term “high-protein carrier:filler food composition” as used herein can refer to a finished food product.

The term “carrier” as used herein can refer to a high-protein food composition, product or ingredient. In some cases, the carrier comprises materials (e.g., protein) produced from fermented biomass, such as, for example, plant biomass.

The term “filler” as used herein can be a composition disposed in close proximity with a carrier as provided herein.

The term “biomass” as used herein can refer to any renewable, organic matter. The various types of biomass can include, but are not limited to, plant biomass and microbial biomass.

The term “fermentation” as used herein can refer to the process of transforming organic matter into different matter using a micro-organism. For example, “fermentation” can refer to transforming sugars or other molecules from biomass to produce alcohols (e.g., ethanol, methanol, butanol); organic acids (e.g., citric acid, acetic acid, itaconic acid, lactic acid, gluconic acid); ketones (e.g., acetone), amino acids (e.g., glutamic acid); gases (e.g., H₂ and CO₂), antibiotics (e.g., penicillin and tetracycline); enzymes; and/or vitamins (e.g., riboflavin, B₁₂, beta-carotene).

Fermenting can be accomplished by any organism suitable for use in a desired fermentation step, including, but not limited to, bacteria, fungi, archaea, and protists. Suitable fermenting organisms include those that can convert mono-, di-, and trisaccharides, especially glucose and maltose, or any other biomass-derived molecule, directly or indirectly to the desired fermentation product (e.g., ethanol, butanol, etc.). Suitable fermenting organisms also include those which can convert non-sugar molecules to desired fermentation products.

In some embodiments, the fermenting is affected by a fungal organism (e.g., yeast or filamentous fungi). The yeast can include strains from a Pichia or Saccharomyces species. In some embodiments, the yeast can be Saccharomyces cerevisiae. In some embodiments, the fermenting is affected by bacteria. For example, the bacteria can be Clostridium acetobutylicum (e.g., when butanol is the desired fermentation product) or Corynebacterium glutamicum (e.g., when monosodium glutamate (MSG) is the desired fermentation product). In some embodiments, the micro-organism (e.g., yeast or bacteria) can be a genetically modified micro-organism. In some instances, the organism can be yeast or other organism having or modified to be active in the presence of high concentrations of alcohol.

The term “plant biomass” as used herein can refer to any plant-derived organic matter (woody or non-woody). Plant biomass can include, but is not limited to, agricultural or food crops (e.g., sugarcane, wheat including wheat flour, tubers, vegetables, lentils, kelp, legumes, soybeans, or corn), food waste valorization, seaweed, plankton (e.g., macroplankton, mesoplankton, microplankton, nanoplankton, picoplankton, and femptoplankton), phytoplankton, or an extract therefrom (e.g., sugar from sugarcane and corn starch from corn), agricultural crop wastes and residues such as corn stover, wheat straw, rice straw, sugar cane bagasse, and the like. Plant biomass further includes, but is not limited to, trees, woody energy crops, wood wastes and residues such as softwood forest matter, barky wastes, sawdust, paper and pulp industry waste streams, wood fiber, and the like. Additionally, grass crops, such as switchgrass and the like have potential to be produced on a large-scale as another plant biomass source.

The term “plant fermentation matter” as used herein can refer to plant biomass transformed into different matter using a micro-organism such as, for example, microbially produced protein. An example of microbially produced protein comprises high-protein, microbially derived protein powder produced from fermented biomass using methods described in co-pending US provisional patent application U.S. 63/428,014, filed Nov. 25, 2022, which is incorporated by reference in its entirety for all purposes.

The term “fungal biomass” as used herein can refer to organic matter derived from a mass of a fungus that has been cultured, fermented, or grown by any suitable process.

The term “fungal fermentation matter” as used herein can refer to fungal biomass transformed into different matter using a micro-organism.

The term “microbial biomass” as used herein can refer to organic matter derived from naturally occurring or genetically modified unicellular organisms and/or multicellular organisms, e.g., organisms from the ocean, lakes, bodies of water, e.g., salt water or fresh water, or on land, and that contains a source of carbohydrate (e.g., cellulose). Microbial biomass can include, but is not limited to, for example protists (e.g., animal (e.g., protozoa such as flagellates, amoeboids, ciliates, and sporozoa) and plant (e.g., algae such alveolates, chlorarachniophytes, cryptomonads, euglenids, glaucophytes, haptophytes, red algae, stramenopiles, and viridaeplantae)), bacteria (e.g., gram positive bacteria, gram negative bacteria, and extremophiles), yeast and/or mixtures of these. In some embodiments, microbial biomass can be obtained from natural sources, e.g., the ocean, lakes, bodies of water, e.g., salt water or fresh water, or on land. Alternatively, or in addition, microbial biomass can be obtained from culture systems, e.g., large scale dry and wet culture systems.

The term “microbial fermentation matter” as used herein can refer to microbial biomass transformed into different matter using a micro-organism. In some cases, the microbially produced protein described herein can be considered microbial fermentation matter. An example of microbial fermentation matter comprises microbially derived protein powder produced from fermented biomass using methods described in US provisional patent application U.S. 63/428,014, filed Nov. 25, 2022.

The term “starch” as used herein can refer to a polymer of glucose readily hydrolyzed by digestive enzymes, e.g., amylases. Starch is usually concentrated in specialized portions of plants, such as potatoes, corn kernels, rice grains, wheat grains, and sugar cane stems.

The term “lignin” as used herein can refer to a polymer material, mainly composed of linked phenolic monomeric compounds, such as p-coumaryl alcohol, coniferyl alcohol, and sinapyl alcohol, which forms the basis of structural rigidity in plants and is frequently referred to as the woody portion of plants. Lignin is also considered to be the non-carbohydrate portion of the cell wall of plants.

The term “cellulose” as used herein can refer to a long-chain polymer polysaccharide carbohydrate of β-glucose of formula (C₆H₁₀O₅)ₙ, usually found in plant cell walls in combination with lignin and any hemicellulose.

The term “hemicellulose” as used herein can refer to a class of plant cell-wall polysaccharides that can be any of several heteropolymers. These include xylan, xyloglucan, arabinoxylan, arabinogalactan, glucuronoxylan, glucomannan and galactomannan. Monomeric components of hemicellulose include, but are not limited to: D-galactose, L-galactose, D-rnannose, L-rhamnose, L-fucose, D-xylose, L-arabinose, and D-glucuronic acid. This class of polysaccharides is found in almost all cell walls along with cellulose. Hemicellulose is lower in weight than cellulose and cannot be extracted by hot water or chelating agents but can be extracted by aqueous alkali. Polymeric chains of hemicellulose bind pectin and cellulose in a network of cross-linked fibers forming the cell walls of most plant cells.

The term “pectin” as used herein can refer to a class of plant cell-wall heterogeneous polysaccharides that can be extracted by treatment with acids and chelating agents. Typically, 70-80% of pectin is found as a linear chain of α-(1-4)-linked D-galacturonic acid monomers. The smaller RG-I fraction of pectin is comprised of alternating (1-4)-linked galacturonic acid and (1-2)-linked L-rhamnose, with substantial arabinogalactan branching emanating from the rhamnose residue. Other monosaccharides, such as D-fucose, D-xylose, apiose, aceric acid, Kdo, Dha, 2-O-methyl-D-fucose, and 2-O-methyl-D-xylose, are found either in the RG-II pectin fraction (<2%), or as minor constituents in the RG-I fraction. Proportions of each of the monosaccharides in relation to D-galacturonic acid vary depending on the individual plant and its micro-environment, the species, and time during the growth cycle. For the same reasons, the homogalacturonan and RG-I fractions can differ widely in their content of methyl esters on GalA residues, and the content of acetyl residue esters on the C-2 and C-3 positions of GalA and neutral sugars.

The term “solvent retention capacity (SRC)” as used herein can refer to a physical test performed on hard and soft wheat flours to determine their end use, baking quality and hydration performance during mixing. The degree of starch gelatinization and low amount of starch damage due to abrasion during grinding may be measured by the sodium carbonate-water solvent retention capacity (SRC sodium carbonate). Solvent retention capacity (SRC) may be measured by mixing a sample of the ingredient or component, such as the stabilized ground coarse fraction or bran component, or a stabilized whole-grain wheat flour, having a weight (A), e.g., about 5 g, with a large excess of water or other solvent, such as an aqueous solution of sodium carbonate (e.g. 5% by weight sodium carbonate) and centrifuging the solvent-flour mixture. The supernatant liquid may then be decanted, and the sample may be weighed to obtain the weight of the centrifuged wet sample (B), wherein the SRC value is calculated by the following equation: SRC value=((B−A)/A)×100.

### Overview

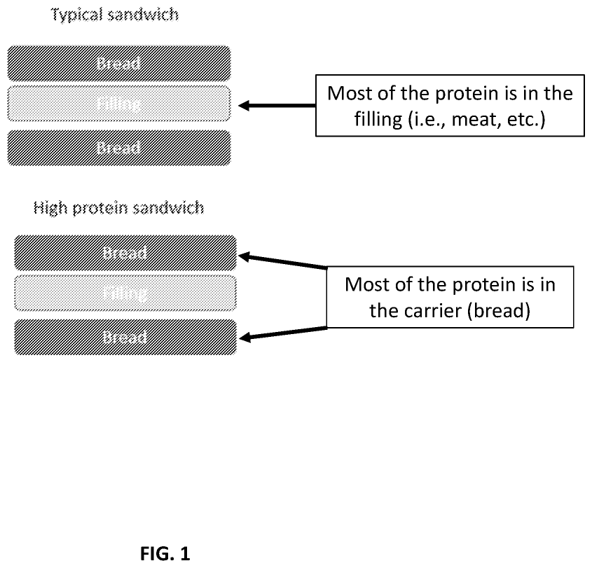

High protein, low-fat diets can provide many health benefits including weight loss, muscle gain, and increased satiety (Johnson et al., The Journal of Nutrition, March 2004). Protein in food can be delivered in a variety of ways, including steaks, sandwiches, soups, etc. Provided herein is a food composition comprising a carrier and a filler and methods of making the same such that most of the protein present in the food composition is in the carrier (e.g., a bun or bread), as depicted in FIG. 1. In some cases, the amount of total protein provided by the carrier in the food composition can be greater than or equal to the amount of total protein provided by the filler in the composition. This increased protein in the carrier can allow for greater delivery of calories via protein, while reducing calories delivered by carbohydrates or fat, which can increase nutritional quality. In some cases, the carrier is a high-quality source of proteins for a subject. In some cases, the carrier provides a plurality of the essential amino acids (EAAs) for a subject. In some cases, the carrier provides at least 20%, at least 40%, at least 60% or at least 80% of the essential amino acids (EAAs) for a subject. In some cases, the carrier provides all of the essential amino acids (EAAs) for a subject. In some cases, the subject is a human subject. In some cases, the subject is a human, and the plurality is 4, 5, 6, 7, 8 or 9 of the essential amino acids. In some cases, the carrier comprises an amino acid distribution profile of between 20% to 50% branched chain amino acids (BCAAs). The carrier in any food composition provided herein can comprise a Protein Digestibility-Corrected Amino Acid Score (PDCAAS) of at least 0.6, at least 0.7, at least 0.8, at least 0.9 or at least 1.0. In some cases, the carrier comprises a PDCAAS of 0.6. In some cases, the carrier comprises a PDCAAS of 0.7. In some cases, the carrier comprises a PDCAAS of 0.8. In some cases, the carrier comprises a PDCAAS of 0.9. In some cases, the carrier comprises a PDCAAS of 1.

Highly optimized microbial protein or protein from other sources (plant or animal) or any combination thereof can be used in any food composition provided herein (e.g., in the carrier and/or in the filler) to provide optimal nutrition. Thus, in some aspects, the present disclosure provides a nutritious, high-protein, low-fat alternative for those seeking food in various formats such as, for example, a sandwich, through the use of high-protein carriers in food compositions comprising a carrier and a filler.

The current disclosure can allow for the use of vegetables, fruits, and other natural/processed products that are typically low in protein that can be used as “fillers” in food products or compositions as provided herein (e.g., sandwiches) without compromising on the daily nutritional intake. Accordingly, these fillers may provide additional taste with low fat, while the protein is provided in the carrier (e.g., bread). In this way, the carriers in any food composition of the present disclosure can provide high-quality protein in the carrier (e.g., bread), irrespective of the filler. The current disclosure further allows for the use of filler that can bring in additional protein from either vegan, or microbial or animal sources in sandwiches or other food products to further supplement daily nutritional needs.

Any food composition provided herein can be comprised of a high-protein powder as described herein produced from fermented biomass (e.g., plant biomass), a comestible, such as dough, starch, and/or flour, and a liquid, such as water.

In some embodiments, the carrier and the filler in any food composition provided herein are present in a desired carrier:filler protein ratio. The carrier:filler protein ratio can be at least 1:0, at least 1:1, at least 2:1, at least 3:1, at least 4:1, at least 5:1, at least 6:1, at least 7:1, at least 8:1, at least 9:1, at least 10:1, at least 15:1, at least 20:1, at least 30:1, at least 40:1, or at least 50:1. The carrier:filler protein ratio can be about 1:1 to 2:1, about 2:1 to 3:1, about 3:1 to 4:1, about 4:1 to 5:1, about 5:1 to 6:1, about 6:1 to 7:1, about 7:1 to 8:1, about 8:1 to 9:1, about 9:1 to 10:1, about 10:1 to 15:1, about 15:1 to 20:1, about 20:1 to 30:1, about 30:1 to 40:1, or about 40:1 to 50:1. In some embodiments, the carrier:filler protein ratio is 1:1 to 1:0.

In some embodiments, any food composition as provided herein (e.g., any high-protein food composition) comprises microbially produced protein. In some embodiments, any food composition as provided herein (e.g., any high-protein food composition) comprises microbially produced protein in combination with a plant protein and/or an animal protein. The microbially produced protein can be derived or obtained from the processing (e.g., fermenting) of plant biomass. In some cases, the plant biomass is fermented to generate the microbially produced protein used in a food composition provided herein. The plant biomass can be fermented by a microbe or microorganism known in the art and/or provided herein. In some cases, the microbe is selected from the group consisting of a fungus, a bacterium, an archaea, a protist and any combination thereof. In some cases, the microbe is a fungus selected from the group consisting of a yeast or filamentous fungus. In some cases, the yeast is a Pichia species or Saccharomyces species. In some cases, the yeast is Saccharomyces cerevisiae. In some cases, the filamentous fungus is a species of filamentous fungus selected from the group consisting of Aspergillus, Fusarium, Rhizopus or Mucor. In some cases, the filamentous fungus is Aspergillus niger. In some cases, the microbe is a species of bacterium selected from the group consisting of Lactobacillus, Bacillus, Bifidobacterium, Clostridium, Enterococcus, Corynebacterium and any combination thereof. In some cases, the bacterium is Corynebacterium glutamicum. In some cases, the bacterium is Clostridium acetobutylicum. In some embodiments, any food composition as provided herein comprises at least 1%, at least 5%, at least 10%, at least 15%, at least 20%, at least 30%, at least 40%, at least 50%, at least 60%, at least 70%, at least 80%, or at least 90% microbially produced protein by weight per serving. In some embodiments, any food composition as provided herein comprises microbially produced protein. In some embodiments, any food composition as provided herein comprises between 1% to 5%, between 10% to 15%, between 15% to 20%, between 20% to 30%, between 30% to 40%, between 40% to 50%, between 50% to 60%, between 60% to 70%, between 70% to 80%, or between 80% to 90% microbially produced protein by weight per serving. In some cases, any food composition provided herein that comprises a microbially produced protein can possess the same or substantially similar organoleptic properties as any food composition known in the art that does not comprise a microbially produced protein.

In some embodiments, any food composition as provided herein comprises at least 1%, at least 5%, at least 10%, at least 15%, at least 20%, at least 30%, at least 40%, at least 50%, at least 60%, at least 70%, at least 80%, or at least 90% total protein by weight per serving. In some embodiments, any food composition as provided herein comprises between 1% to 5%, between 10% to 15%, between 15% to 20%, between 20% to 30%, between 30% to 40%, between 40% to 50%, between 50% to 60%, between 60% to 70%, between 70% to 80%, or between 80% to 90% total protein by weight per serving.

In some embodiments, any food composition as provided herein comprises at least 1%, at least 5%, at least 10%, at least 15%, at least 20%, at least 30%, at least 40%, at least 50%, at least 60%, at least 70%, at least 80%, at least 90%, at least 100%, at least 110%, at least 120%, at least 130%, at least 140%, at least 150%, at least 160%, at least 170%, at least 180%, at least 190%, at least 200%, at least 210%, at least 220%, at least 230%, at least 240%, at least 250%, at least 260%, at least 270%, at least 280%, at least 290%, at least 300%, at least 310%, at least 320%, at least 330%, at least 340%, at least 350%, at least 360%, at least 370%, at least 380%, at least 390%, at least 400%, at least 410%, at least 420%, at least 430%, at least 440%, at least 450%, at least 460%, at least 470%, at least 480%, at least 490%, or at least 500% more calories from protein compared to a generic composition per serving. The generic composition can be a generic composition as described herein.

In some embodiments, any food composition as provided herein comprises between 1% to 5%, between 10% to 15%, between 15% to 20%, between 20% to 30%, between 30% to 40%, between 40% to 50%, between 50% to 60%, between 60% to 70%, between 70% to 80%, or between 80% to 90%, between 90% to 100%, between 100% to 110%, between 110% to 120%, between 120% to 130%, between 130% to 140%, between 140% to 150%, between 150% to 160%, between 160% to 170%, between 170% to 180%, between 180% to 190%, between 190% to 200%, between 200% to 210%, between 210% to 220%, between 220% to 230%, between 230% to 240%, between 240% to 250%, between 250% to 260%, between 260% to 270%, between 270% to 280%, between 280% to 290%, between 290% to 300%, between 300% to 310%, between 310% to 320%, between 320% to 330%, between 330% to 340%, between 340% to 350%, between 350% to 360%, between 360% to 370%, between 370% to 380%, between 380% to 390%, between 390% to 400%, between 400% to 410%, between 410% to 420%, between 420% to 430%, between 430% to 440%, between 440% to 450%, between 450% to 460%, between 460% to 470%, between 470% to 480%, between 480% to 490%, or between 490% to 500% more calories from protein compared to a generic composition per serving. The generic composition can be a generic composition as described herein.

In some embodiments, any food composition as provided herein comprises fewer calories from carbohydrates compared to a generic composition. In some embodiments, any food composition as provided herein comprises at least 1%, at least 5%, at least 10%, at least 15%, at least 20%, at least 30%, at least 40%, at least 50%, at least 60%, at least 70%, at least 80%, or at least 90% fewer calories from carbohydrates compared to a generic composition per serving.

In some embodiments, any food composition as provided herein comprises fewer calories from carbohydrates compared to a generic composition. In some embodiments, any food composition as provided herein comprises between 1% to 5%, between 10% to 15%, between 15% to 20%, between 20% to 30%, between 30% to 40%, between 40% to 50%, between 50% to 60%, between 60% to 70%, between 70% to 80%, or between 80% to 90% fewer calories from carbohydrates compared to a generic composition per serving. The generic composition can be a generic composition as described herein.

In some embodiments, any food composition as provided herein comprises about 10 calories, about 20 calories, about 30 calories, about 40 calories, about 50 calories, about 60 calories, about 70 calories, about 80 calories, about 90 calories, about 100 calories, about 110 calories, about 120 calories, about 130 calories, about 140 calories, about 150 calories, about 160 calories, about 170 calories, about 180 calories, about 190 calories, about 200 calories, about 210 calories, about 220 calories, about 230 calories, about 240 calories, about 250 calories, about 260 calories, about 270 calories, about 280 calories, about 290 calories, about 300 calories, about 310 calories, about 320 calories, about 330 calories, about 340 calories, about 350 calories, about 360 calories, about 370 calories, about 380 calories, about 390 calories, about 400 calories, about 410 calories, about 420 calories, about 430 calories, about 440 calories, about 450 calories, about 460 calories, about 470 calories, about 480 calories, about 490 calories, about 500 calories, about 510 calories, about 520 calories, about 530 calories, about 540 calories, about 550 calories, about 560 calories, about 570 calories, about 580 calories, about 590 calories, about 600 calories, about 610 calories, about 620 calories, about 630 calories, about 640 calories, about 650 calories, about 660 calories, about 670 calories, about 680 calories, about 690 calories, about 700 calories, about 710 calories, about 720 calories, about 730 calories, about 740 calories, about 750 calories, about 760 calories, about 770 calories, about 780 calories, about 790 calories, about 800 calories, about 810 calories, about 820 calories, about 830 calories, about 840 calories, about 850 calories, about 860 calories, about 870 calories, about 880 calories, about 890 calories, about 900 calories, about 910 calories, about 920 calories, about 930 calories, about 940 calories, about 950 calories, about 960 calories, about 970 calories, about 980 calories, about 990 calories, about 1,000 calories, about 1,110 calories, about 1,120 calories, about 1,130 calories, about 1,140 calories, about 1,150 calories, about 1,160 calories, about 1,170 calories, about 1,180 calories, about 1,190 calories, about 1,200 calories, about 1,210 calories, about 1,220 calories, about 1,230 calories, about 1,240 calories, about 1,250 calories, about 1,260 calories, about 1,270 calories, about 1,280 calories, about 1,290 calories, about 1,300 calories, about 1,310 calories, about 1,320 calories, about 1,330 calories, about 1,340 calories, about 1,350 calories, about 1,360 calories, about 1,370 calories, about 1,380 calories, about 1,390 calories, or about 1,400 calories per serving.

In some embodiments, any food composition as provided herein comprises between 10 calories to 20 calories, between 20 calories to 30 calories, between 30 calories to 40 calories, between 40 calories to 50 calories, between 50 calories to 60 calories, between 60 calories to 70 calories, between 70 calories to 80 calories, or between 80 calories to 90 calories, between 90 calories to 100 calories, between 100 calories to 110 calories, between 110 calories to 120 calories, between 120 calories to 130 calories, between 130 calories to 140 calories, between 140 calories to 150 calories, between 150 calories to 160 calories, between 160 calories to 170 calories, between 170 calories to 180 calories, between 180 calories to 190 calories, between 190 calories to 200 calories, between 200 calories to 210 calories, between 210 calories to 220 calories, between 220 calories to 230 calories, between 230 calories to 240 calories, between 240 calories to 250 calories, between 250 calories to 260 calories, between 260 calories to 270 calories, between 270 calories to 280 calories, between 280 calories to 290 calories, between 290 calories to 300 calories, between 300 calories to 310 calories, between 310 calories to 320 calories, between 320 calories to 330 calories, between 330 calories to 340 calories, between 340 calories to 350 calories, between 350 calories to 360 calories, between 360 calories to 370 calories, between 370 calories to 380 calories, between 380 calories to 390 calories, between 390 calories to 400 calories, between 400 calories to 410 calories, between 410 calories to 420 calories, between 420 calories to 430 calories, between 430 calories to 440 calories, between 440 calories to 450 calories, between 450 calories to 460 calories, between 460 calories to 470 calories, between 470 calories to 480 calories, between 480 calories to 490 calories, between 490 calories to 500 calories, between 500 calories to 510 calories, between 510 calories to 520 calories, between 520 calories to 530 calories, between 530 calories to 540 calories, between 540 calories to 550 calories, between 550 calories to 560 calories, between 560 calories to 570 calories, between 570 calories to 580 calories, between 580 calories to 590 calories, between 590 calories to 600 calories, between 600 calories to 610 calories, between 610 calories to 620 calories, between 620 calories to 630 calories, between 630 calories to 640 calories, between 640 calories to 650 calories, between 650 calories to 660 calories, between 660 calories to 670 calories, between 670 calories to 680 calories, between 680 calories to 690 calories, between 690 calories to 700 calories, between 700 calories to 710 calories, between 710 calories to 720 calories, between 720 calories to 730 calories, between 730 calories to 740 calories, between 740 calories to 750 calories, between 750 calories to 760 calories, between 760 calories to 770 calories, between 770 calories to 780 calories, between 780 calories to 790 calories, between 790 calories to 800 calories, between 800 calories to 810 calories, between 810 calories to 820 calories, between 820 calories to 830 calories, between 830 calories to 840 calories, between 840 calories to 850 calories, between 850 calories to 860 calories, between 860 calories to 870 calories, between 870 calories to 880 calories, between 880 calories to 890 calories, between 890 calories to 900 calories, between 900 calories to 910 calories, between 910 calories to 920 calories, between 920 calories to 930 calories, between 930 calories to 940 calories, between 940 calories to 950 calories, between 950 calories to 960 calories, between 960 calories to 970 calories, between 970 calories to 980 calories, between 980 calories to 990 calories, between 990 calories to 1,000 calories, between 1,000 calories to 1,010 calories, between 1,010 calories to 1,020 calories, between 1,020 calories to 1,030 calories, between 1,030 calories to 1,040 calories, between 1,040 calories to 1,050 calories, between 1,050 calories to 1,060 calories, between 1,060 calories to 1,070 calories, between 1,070 calories to 1,080 calories, between 1,080 calories to 1,090 calories, between 1,090 calories to 1,100 calories, between 1,100 calories to 1,110 calories, between 1,110 calories to 1,120 calories, between 1,120 calories to 1,130 calories, between 1,130 calories to 1,140 calories, between 1,140 calories to 1,150 calories, between 1,150 calories to 1,160 calories, between 1,160 calories to 1,170 calories, between 1,170 calories to 1,180 calories, between 1,180 calories to 1,190 calories, between 1,190 calories to 1,200 calories, between 1,200 calories to 1,210 calories, between 1,210 calories to 1,220 calories, between 1,220 calories to 1,230 calories, between 1,230 calories to 1,240 calories, between 1,240 calories to 1,250 calories, between 1,250 calories to 1,260 calories, between 1,260 calories to 1,270 calories, between 1,270 calories to 1,280 calories, between 1,280 calories to 1,290 calories, between 1,290 calories to 1,300 calories, between 1,300 calories to 1,310 calories, between 1,310 calories to 1,320 calories, between 1,320 calories to 1,330 calories, between 1,330 calories to 1,340 calories, between 1,340 calories to 1,350 calories, between 1,350 calories to 1,360 calories, between 1,360 calories to 1,370 calories, between 1,370 calories to 1,380 calories, between 1,380 calories to 1,390 calories, or between 1,390 calories to 1,400 calories per serving.

In one aspect, provided herein is a method for producing a high-protein food composition. The method can comprise providing a high-protein powder, a comestible, and a liquid. The method can further comprise mixing the high-protein powder, comestible, and liquid into a composition. In some cases, the high-protein powder, comestible, and liquid are mixed into a homogeneous composition. In some cases, the composition is heated (e.g., baking or cooking) the homogeneous composition to produce a carrier. The method can further comprise leavening the composition following the mixing. In some cases, following the leavening, the composition is heated (e.g., baking or cooking) the homogeneous composition to produce a carrier. Following formation of the carrier, the method can further comprise disposing or dispensing a filler with the carrier to generate a high-protein carrier;filler food composition.

In some embodiments, the comestible is mixed with the high-protein powder at a comestible:high-protein powder ratio of at least 1:1, at least 1:2, at least 1:3, at least 1:4, at least 1:5, at least 1:6, at least 1:7, at least 1:8, at least 1:9, at least 1:10, at least 1:20, at least 1:30, at least 1:40, or at least 1:50. In some embodiments, the comestible is mixed with the high-protein powder at a high-protein powder:comestible ratio of between 1:1 to 1:2, between 1:2 to 1:3, between 1:3 to 1:4, between 1:4 to 1:5, between 1:5 to 1:6, between 1:6 to 1:7, between 1:7 to 1:8, between 1:8 to 1:9, between 1:9 to 1:10, between 1:10 to 1:20, between 1:20 to 1:30, between 1:30 to 1:40, or between 1:40 to 1:50.

In some embodiments, the heating increases the thickness of the high-protein food composition.

In some embodiments, any food composition (e.g., high-protein food composition) as provided herein has a thickness less than 1 centimeter. In some embodiments, the high-protein food composition has a thickness of at least 1 centimeter, at least 2 centimeters, at least 3 centimeters, at least 4 centimeters, at least 5 centimeters, at least 6 centimeters, at least 7 centimeters, at least 8 centimeters, at least 9 centimeters, or at least 10 centimeters. In some embodiments, the high-protein food composition has a thickness of between 1 centimeter to 2 centimeters, between 2 centimeters to 3 centimeters, between 3 centimeters to 4 centimeters, between 4 centimeters to 5 centimeters, between 5 centimeters to 6 centimeters, between 6 centimeters to 7 centimeters, between 7 centimeters to 8 centimeters, between 8 centimeters to 9 centimeters, or between 9 centimeters to 10 centimeters.

In some embodiments, the liquid is mixed with an emulsifier. In some embodiments, the emulsifier comprises acacia, acetic acid esters, ammonium phosphatide, baker's year glycan, brominated vegetable oil, carboxymethylcellulose, carrageenan, diacetyl tartaric acid esters, dextrin, guar gum, lactic acid esters, lecithin (soy and egg), magnesium stearate, mono and diglycerides, phosphates, polyglycerol esters, polysorbate 60, polysorbate 65, polysorbate 80 (P80), propylene glycol esters of fatty acids, sodium stearolyllactylate (SSL), sorbitan monostearate, sucrose acetate isobutyrate, sucrose fatty acid ester, and/or xanthum gum.

### Carrier

In some embodiments, the carrier for use in a food composition (e.g., carrier:filler food composition) as provided herein may be, but is not limited to, yeast leavened bread, chemically leavened bread, pizza crust, artisan bread, buns, batters (e.g., cookie batter), breading mix, croutons, ready-to-bake cake mix, rolls, rolls in a ready to bake format, uncooked filled dough product for consumers (e.g., fruit and/or jelly filling), soup, dried soup base, body-building powder, protein shakes, and/or diet shakes.

The carrier for use in a food composition (e.g., carrier:filler food composition) as provided herein may be produced from a high protein powder.

In one aspect, provided herein is a method for producing a carrier for use in a carrier:filler food composition provided herein. The method can comprise providing a high-protein powder, a comestible, and a liquid. The method can further comprise mixing the high-protein powder, comestible, and liquid into a composition. In some cases, the high-protein powder, comestible, and liquid are mixed into a homogeneous composition. In some cases, the composition is heated (e.g., baking or cooking) the homogeneous composition to produce a carrier. The method can further comprise leavening the composition following the mixing. In some cases, following the leavening, the composition is heated (e.g., baking or cooking) the homogeneous composition to produce a carrier.

The high-protein powder may comprise 5, 6, 7, 8, 9, 10, 11, 12, 13, 14, 15, 16, 17, 18, 19, 20, 21, 22, 23, 24, 25, 26, 27, 28, 29 or 30 grams (g) of protein per serving. In some cases, the serving is 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g). The high-protein powder may comprise at least, at most or about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99% or 100% of protein by weight per serving.

The high-protein powder such as that used, for example, in a carrier as provided herein may be comprised of a mixture, blend or plurality of proteins selected from the group consisting of animal proteins, plant proteins, microbial proteins and any combination thereof. In one embodiment, the high-protein powder comprises a mixture of animal proteins. In one embodiment, the high-protein powder comprises a mixture of plant proteins. In one embodiment, the high-protein powder comprises a mixture of animal proteins and plant proteins. In one embodiment, the high-protein powder comprises a mixture of microbial proteins and plant proteins. In one embodiment, the high-protein powder comprises a mixture of animal proteins, plant proteins and microbial proteins. In some embodiments, the high-protein powder or carrier for use in a food composition (e.g., carrier:filler food composition) as provided herein comprises microbially produced protein. In some cases, the high protein powder or carrier comprises microbially produced protein in combination with a plant protein and/or an animal protein.

In some embodiments, the high-protein powder or carrier comprises at least 1%, at least 5%, at least 10%, at least 15%, at least 20%, at least 30%, at least 40%, at least 50%, at least 60%, at least 70%, at least 80%, or at least 90% microbially produced protein by weight. In some embodiments, the high-protein powder or carrier comprises between 1% to 5%, between 10% to 15%, between 15% to 20%, between 20% to 30%, between 30% to 40%, between 40% to 50%, between 50% to 60%, between 60% to 70%, between 70% to 80%, or between 80% to 90% microbially produced protein by weight. In some embodiments, the ratio of microbially produced protein to other source of protein in the high-protein powder or carrier is 0.1 to 1, 0.5 to 1, 1 to 1, 1.5 to 1, 2 to 1, 3 to 1, 4 to 1, 5 to 1, 6 to 1, 7 to 1, 8 to 1, 9 to 1, 10 to 1, 15 to 1 or 20 to 1.

The microbially produced protein can be derived or obtained from the processing (e.g., fermenting) of plant biomass. In some cases, the plant biomass is fermented to generate the microbially produced protein used in a high-protein powder or carrier as provided herein. The plant biomass can be fermented by a microbe or microorganism known in the art and/or provided herein. In some cases, the microbe is selected from the group consisting of a fungus, a bacterium, an archaea, a protist and any combination thereof. In some cases, the microbe is a fungus selected from the group consisting of a yeast or filamentous fungus. In some cases, the yeast is a Pichia species or Saccharomyces species. In some cases, the yeast is Saccharomyces cerevisiae. In some cases, the filamentous fungus is a species of filamentous fungus selected from the group consisting of Aspergillus, Fusarium, Rhizopus or Mucor. In some cases, the filamentous fungus is Aspergillus niger. In some cases, the microbe is a species of bacterium selected from the group consisting of Lactobacillus, Bacillus, Bifidobacterium, Clostridium, Enterococcus, Corynebacterium and any combination thereof. In some cases, the bacterium is Corynebacterium glutamicum. In some cases, the bacterium is Clostridium acetobutylicum. In one embodiment, the high-protein powder or carrier comprises a blend of microbially produced proteins and plant proteins, wherein the microbially produced protein is obtained by the fermentation of plant biomass by a microbe, wherein the microbe is S. cerevisiae. Further to this embodiment, the high-protein powder or carrier can comprise at least 50 g of protein per 100 g of the high-protein powder or carrier.

The term hydration limit can refer to the upper limit of a liquid that a comestible, such as flour, may absorb to form a dough. For example, a comestible may have a hydration limit of 80% to form a dough.

Regardless of the protein source, a high-protein powder or carrier as provided herein can possesses a hydration limit that allows for the improvement of texture in a food composition or product comprising said protein powder.

In some embodiments, the hydration limit of the high protein powder or carrier is at least 10%, at least 20%, at least 30%, at least 40%, at least 50%, at least 60%, at least 70%, at least 80%, at least 90%, at least 100%, at least 110%, at least 120%, at least 130%, at least 140%, at least 150%, at least 160%, at least 170%, at least 180%, at least 190%, or at least 200%.

In some embodiments, the hydration limit of the high protein powder or carrier is at least 10%, between 10% to 20%, between 20% to 30%, between 30% to 40%, between 40% to 50%, between 50% to 60%, between 60% to 70%, between 70% to 80%, between 80% to 90%, between 90% to 100%, between 100% to 110%, between 110% to 120%, between 120% to 130%, between 130% to 140%, between 140% to 150%, between 150% to 160%, between 160% to 170%, between 170% to 180%, between 180% to 190%, or between 190% to 200%.

In one embodiment, the high-protein powder or carrier comprises a desired water hydration capacity (WHC). The desired WHC can be from 80 grams (g) to 300 g of water per 100 g of protein or 80 g to 150 g of water per 100 g of protein or protein powder. In some cases, the high-protein powder or carrier possesses at most, at least, exactly or about 70, 75, 80, 85, 90, 95, 100, 105, 110, 115, 120, 125, 130, 135, 140, 145, 150, 155, 160, 165, 170, 175, 180, 190, 200, 210, 220, 230, 240, 250, 260, 270, 280, 290, or 300 g of water per 100 g of protein or protein powder.

In one embodiment, the solvent retention content (SRC) of the high-protein powder or carrier provided herein is at least 100%, at least 105%, at least 110%, at least 115%, at least 120%, at least 125%, at least 130%, at least 140%, at least 150%, at least 160%, at least 170%, at least 180%, at least 190%, or at least 200%.

In one embodiment, the solvent retention content (SRC) of the high-protein powder or carrier provided herein is between 100% to 105%, between 105% to 110%, between 110% to 115%, between 115% to 120%, between 120% to 125%, between 125% to 130%, between 130% to 140%, between 140% to 150%, between 150% to 160%, between 160% to 170%, between 170% to 180%, between 180% to 190%, or at between 190% to 200%.

In some embodiments, the carrier for use in a food composition (e.g., carrier:filler food composition) as provided herein does not have any air pockets.

In some embodiments, the carrier for use in a food composition (e.g., carrier:filler food composition) as provided herein has at least 1 air pocket/mm³, at least 10 air pockets/mm³, at least 100 air pockets/mm³, at least 1,000 air pockets/mm³, at least 10,000 air pockets/mm³, or at least 100,000 air pockets/mm³. In some embodiments, the carrier has between 1 air pocket/mm³ to 10 air pockets/mm³, between 10 air pockets/mm³ to 100 air pockets/mm³, between 100 air pockets/mm³ to 1,000 air pockets/mm³, between 1,000 air pockets/mm³, between 10,000 air pockets/mm³, or at least at least 100,000 air pockets/mm³.

In some embodiments, the air pockets have an average radius of at least 0.01 mm, at least 0.1 mm, at least 0.2 mm, at least 0.3 mm, at least 0.4 mm, at least 0.5 mm, at least 0.6 mm, at least 0.7 mm, at least 0.8 mm, at least 0.9 mm, at least 1 mm. In some embodiments, air pockets have an average radius of between 0.01 mm to 0.1 mm, between 0.1 mm to 0.2 mm, between 0.2 mm to 0.3 mm, between 0.3 mm to 0.4 mm, between 0.4 mm to 0.5 mm, between 0.5 mm to 0.6 mm, between 0.6 mm to 0.7 mm, between 0.7 mm to 0.8 mm, between 0.8 mm to 0.9 mm, or between 0.9 mm to 1 mm.

In some embodiments, the carrier for use in a food composition (e.g., carrier:filler food composition) as provided herein has a thickness of at least 1 centimeter, at least 2 centimeters, at least 3 centimeters, at least 4 centimeters, at least 5 centimeters, at least 6 centimeters, at least 7 centimeters, at least 8 centimeters, at least 9 centimeters, or at least 10 centimeters. In some embodiments, the carrier has a thickness of at least 1 centimeter, at least 2 centimeters, at least 3 centimeters, at least 4 centimeters, at least 5 centimeters, at least 6 centimeters, at least 7 centimeters, at least 8 centimeters, at least 9 centimeters, or at least 10 centimeters.

As shown in Table 1A and Table 1B, carriers of the current disclosure confer unique advantages to food compositions that comprise said carriers (Table 1B) when compared to generic carriers (Table 1A) with similar calorie ranges. Additional ranges of carriers of the present disclosure are shown in Table 2A and compared to generic carriers in Table 2B. In some embodiments, the total protein in a carrier of the current disclosure is increased, while carbohydrates are reduced, while maintaining or reducing total calories. In other words, within a given calorie range, carriers from the present disclosure confer higher protein, and reduced carbohydrates.

None of the generic sandwiches known currently in the art can achieve these ratios. For a higher protein to be achieved, for example, a generic sandwich would have to use more calories, as the carrier is not able to provide increased quantity of high-quality protein.

TABLE 1A
Ratios of calories derived from protein, fat, and carbohydrates, for generic carriers.

| | Generic Carrier | | | | | | | | | |
|---|---|---|---|---|---|---|---|---|---|---|
| | Percentage calories | | | | | | | | | |
| | from protein, carbs | | | | Protein | | Carb | | Fat | |
| | and fat | | | Total | Calories | weight | Calories | weight | Calories | weight |
| | Protein | Carb | Fat | calories | (Kcal) | (g) | (Kcal) | (g) | (Kcal) | (g) |
| Range 1 | 13% | 75% | 12% | 150 | 20 | 5 | 113 | 28 | 18 | 2 |
| Range 2 | 20% | 38% | 42% | 420 | 84 | 21 | 160 | 40 | 176 | 20 |
| Range 3 | 18% | 46% | 37% | 500 | 90 | 23 | 230 | 58 | 185 | 21 |
| Range 4 | 25% | 60% | 15% | 270 | 68 | 17 | 162 | 41 | 41 | 5 |
| Range 5 | 22% | 65% | 13% | 390 | 86 | 21 | 254 | 63 | 51 | 6 |
| Range 6 | 27% | 47% | 26% | 370 | 100 | 25 | 174 | 43 | 96 | 11 |
| Range 7 | 25% | 53% | 22% | 450 | 113 | 28 | 239 | 60 | 99 | 11 |
| Range 8 | 12% | 48% | 40% | 420 | 50 | 13 | 202 | 50 | 168 | 19 |
| Range 9 | 12% | 55% | 33% | 530 | 64 | 16 | 292 | 73 | 175 | 19 |
| Range 10 | 20% | 42% | 38% | 390 | 78 | 20 | 164 | 41 | 148 | 16 |
| Range 11 | 17% | 53% | 30% | 410 | 70 | 17 | 217 | 54 | 123 | 14 |

TABLE 1B
Ratios of calories derived from protein, fat, and carbohydrates,
for carriers of the current disclosure.

| | Carrier of the Current Disclosure | | | | | | | | | |
|---|---|---|---|---|---|---|---|---|---|---|
| | Percentage calories | | | | | | | | | |
| | from protein, carbs | | | | Protein | | Carb | | Fat | |
| | and fat | | | Total | Calories | weight | Calories | weight | Calories | weight |
| | Protein | Carb | Fat | calories | (Kcal) | (g) | (Kcal) | (g) | (Kcal) | (g) |
| Range 1 | 51% | 38% | 11% | 120 | 61 | 15 | 46 | 11 | 13 | 1 |
| Range 2 | 30% | 30% | 40% | 420 | 126 | 32 | 126 | 32 | 168 | 19 |
| Range 3 | 35% | 20% | 45% | 390 | 137 | 34 | 78 | 20 | 176 | 20 |
| Range 4 | 50% | 35% | 15% | 250 | 125 | 31 | 88 | 22 | 38 | 4 |
| Range 5 | 40% | 45% | 15% | 340 | 136 | 34 | 153 | 38 | 51 | 6 |
| Range 6 | 45% | 27% | 28% | 340 | 153 | 38 | 92 | 23 | 95 | 11 |
| Range 7 | 40% | 35% | 25% | 395 | 158 | 40 | 138 | 35 | 99 | 11 |
| Range 8 | 26% | 31% | 43% | 390 | 101 | 25 | 121 | 30 | 168 | 19 |
| Range 9 | 25% | 35% | 40% | 450 | 113 | 28 | 158 | 39 | 180 | 20 |
| Range 10 | 40% | 20% | 40% | 320 | 128 | 32 | 64 | 16 | 128 | 14 |
| Range 11 | 35% | 35% | 30% | 400 | 140 | 35 | 140 | 35 | 120 | 13 |

TABLE 2A
Additional ranges of ratios of calories derived from protein,
fat, and carbohydrates, for carriers of the current disclosure.

Carrier of the Present Disclosure

| | Percentage calories from | | | |
|---|---|---|---|---|
| | protein, carbs and fat | | | Total |
| | Protein | Carb | Fat | calories |
| Range 1 | 30% | 30% | 40% | 420 |
| Range 2 | 35% | 20% | 45% | 390 |
| Range 3 | 50% | 35% | 15% | 250 |
| Range 4 | 40% | 45% | 15% | 340 |
| Range 5 | 45% | 27% | 28% | 340 |
| Range 6 | 40% | 35% | 25% | 395 |
| Range 7 | 25% | 30% | 45% | 400 |
| Range 8 | 25% | 35% | 40% | 450 |
| Range 9 | 40% | 20% | 40% | 320 |
| Range 10 | 35% | 35% | 30% | 400 |

TABLE 2B
Additional ranges of ratios of calories derived from protein,
fat, and carbohydrates, for generic carriers.

Generic Carrier

| | Percentage calories from | | | |
|---|---|---|---|---|
| | protein, carbs and fat | | | Total |
| | Protein | Carb | Fat | calories |
| Range 1 | 20% | 38% | 42% | 420 |
| Range 2 | 18% | 46% | 37% | 500 |
| Range 3 | 25% | 60% | 15% | 270 |
| Range 4 | 22% | 65% | 13% | 390 |
| Range 5 | 27% | 47% | 26% | 370 |
| Range 6 | 25% | 53% | 22% | 450 |
| Range 7 | 12% | 48% | 40% | 420 |
| Range 8 | 12% | 55% | 33% | 530 |
| Range 9 | 20% | 42% | 38% | 390 |
| Range 10 | 17% | 53% | 30% | 410 |

Amino Acid Content

Maize, rice, and wheat are staple foods in many regions of the world; however, proteins from these grains are limited in certain amino acids, making their protein of poor dietary quality. For example, maize protein is limited in the amino acids lysine and tryptophan. Rice and wheat are additionally limiting in lysine. Consequently, populations that rely heavily on these foods are lacking in at least one essential amino acid and require supplementation from other foods. The high-protein food compositions or products of the present disclosure comprise a high-protein content containing all 20 amino acids, Histidine (H), Isoleucine (I), Leucine (L), Lysine (K), Methionine (M), Phenylalanine (F), Threonine (T), Tryptophan (W), Valine (V), Alanine (A), Arginine (R), Asparagine (N), Aspartic Acid (D), Glutamine (Q), Glutamic Acid (E), Glycine (G), Proline (P), Serine (S), Cysteine (C) and Tyrosine (Y).

In some embodiments, regardless of source, the high-protein powder such as that used, for example, in a carrier as provided herein provides protein of high nutritional quality.

In some embodiments, the amino acid (protein) content of the high protein powder or carrier comprises all 20 amino acids.

In some embodiments, the amino acid (protein) content comprising all 20 amino acids of the high protein powder or carrier of the disclosure is about 20% to 25%, about 25% to 30%, about 30% to 35%, about 35% to 40%, about 40% to 45%, about 45% to 50%, about 50% to 55%, about 55% to 60%, about 60% to 65%, about 65% to 70%, about 70% to 75%, about 75% to 80%, about 80% to 85%, about 85% to 90%, about 90% to 95%, or about 95% to 100%.

In some embodiments, the amino acid (protein) content comprising all 20 amino acids of the high protein powder or carrier of the disclosure is at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or at least 95%, or 100%.

Among the amino acids are non-essential amino acids (NEAAs), conditionally-essential amino acids (CEAA), and essential amino acids (EAA). Among the EAA are branched-chain amino acids (BCAAs). A BCAA is an amino acid having an aliphatic side-chain with a branch (a central carbon atom bound to three or more carbon atoms). BCAAs include leucine, isoleucine, and valine.

In some embodiments, the BCAA content of the carrier or a high-protein powder of the disclosure is about 20% to 25%, about 25% to 30%, about 30% to 35%, about 35% to 40%, about 40% to 45%, about 45% to 50%, about 50% to 55%, about 55% to 60%, about 60% to 65%, about 65% to 70%, about 70% to 75%, about 75% to 80%, about 80% to 85%, about 85% to 90%, about 90% to 95%, or about 95% to 100%. In some cases, the high protein powder or carrier comprises an amino acid distribution profile of between 20% to 50% branched chain amino acids (BCAAs).

In some embodiments, the BCAA content of the carrier or a high-protein powder of the disclosure is at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or at least 95%, or 100%.

In some embodiments, the high protein powder or carrier comprises at least 50% by weight EAAs. In some embodiments, the high protein powder or carrier comprises at least 55% by weight EAAs, at least 60% by weight EAAs, at least 65% by weight EAAs, at least 70% by weight EAAs, at least by weight 75% EAAs, at least 80% by weight EAAs, at least 85% by weight EAAs, at least 90% by weight EAAs, or at least 95% by weight EAAs, at least 96% by weight EAAs, at least 97% by weight EAAs, at least 98% by weight EAAs, at least 99% by weight EAAs, or 100% EAAs. In some embodiments, the high protein powder or carrier comprises from 50 to 100% by weight EAAs, from 60 to 100% by weight EAAs, from 70 to 100% by weight EAAs, from 80 to 90% by weight EAAs, from 60 to 90% by weight EAAs, from 60 to 80% by weight EAAs, from 70 to 90% by weight EAAs, from 60 to 70% by weight EAAs, from 70 to 80% by weight EAAs, from 80 to 90% by weight EAAs, and from 90 to 100% by weight EAAs. In some embodiments, the high protein powder or carrier comprises from 90% to 100% EAAs and CEAAs. In some embodiments, the carrier comprises 100% EAAs and CEAAs.

In some cases, the high protein powder or carrier provides a plurality of the essential amino acids (EAAs) for a subject. In some cases, the high protein powder or carrier provides at least 20%, at least 40%, at least 60% or at least 80% of the essential amino acids (EAAs) for a subject. In some cases, the high protein powder or carrier provides all of the essential amino acids (EAAs) for a subject. In some cases, the subject is a human subject. In some cases, the subject is a human, and the plurality is 4, 5, 6, 7, 8 or 9 of the essential amino acids.

In some embodiments, the average protein nutritional quality score of the carrier or high-protein powder may have a PDCAAS of at least 0.60, at least 0.65, at least 0.75, or at least 0.80, or at least 0.85, or at least 0.86, or at least 0.87, or at least 0.88, or at least 0.89, or at least 0.90, or at least 0.91, or at least 0.92, or at least 0.93, or at least 0.94, or at least 0.95, or at least 0.96, or at least 0.97, or at least 0.98, or at least 0.99 or at least 1.

In some embodiments, the average protein nutritional quality score of the carrier or high-protein powder may have a PDCAAS about 0.60 to 0.65, about 0.65 to 0.70, about 0.70 to 0.75, about 0.75 to 0.80, or about 0.80 to 0.85, or about 0.85 to 0.9, or about 0.90 to 0.92, or about 0.92 to 0.94, or about 0.94 to 0.96, or about 0.96 to 0.98, or about 0.98 to 1.

In some embodiments, the average protein nutritional quality score of the carrier or high-protein powder may have an IVPDCAAS of at least 0.60, at least 0.65, at least 0.75, or at least 0.80, or at least 0.85, or at least 0.86, or at least 0.87, or at least 0.88, or at least 0.89, or at least 0, 90, or at least 0.91, or at least 0.92, or at least 0.93, or at least 0.94, or at least 0.95, or at least 0.96, or at least 0.97, or at least 0.98, or at least 0.99 or at least 1.

In some embodiments, the average protein nutritional quality score of the carrier or high-protein powder may have an IVPDCAAS about 0.60 to 0.65, about 0.65 to 0.70, about 0.70 to 0.75, about 0.75 to 0.80, or about 0.80 to 0.85, or about 0.85 to 0.9, or about 0.90 to 0.92, or about 0.92 to 0.94, or about 0.94 to 0.96, or about 0.96 to 0.98, or about 0.98 to 1.

In some embodiments, the average protein nutritional quality score of the carrier or high-protein powder may have a PDCAAS of at least 1, or at least 1.25, or at least 1.5, or at least 1.75, or at least 2 or at least 2.25, or at least 2.5, or at least 2.75, or at least 3, or at least 3.25, or at least 3.6.

In some embodiments, the average protein nutritional quality score of the carrier or high-protein powder may have a PDCAAS of about 1 to 1.25, or about 1.25 to 1.50, or about 1.50 to 1.75, or about 1.75 to 2, or about 2 to 2.25, or about 2.25 to 2.50, or about 2.50 to 2.75, or about 2.75 to 3, or about 3 to 3.25, or about 3.25 to 3.50, or about 3.50 to 3.6.

In some embodiments, the average protein nutritional quality score of the carrier or high-protein powder may have an IVPDCAAS of at least 1, or at least 1.25, or at least 1.5, or at least 1.75, or at least 2 or at least 2.25, or at least 2.5, or at least 2.75, or at least 3, or at least 3.25, or at least 3.5, or at least 3.75, or at least 4.

In some embodiments, the average protein nutritional quality score of the carrier or high-protein powder may have an IVPDCAAS of about 1 to 1.25, or about 1.25 to 1.50, or about 1.50 to 1.75, or about 1.75 to 2, or about 2 to 2.25, or about 2.25 to 2.50, or about 2.50 to 2.75, or about 2.75 to 3, or about 3 to 3.25, or about 3.25 to 3.50, or about 3.50 to 3.75, or about 3.75 to 4 In some embodiments, the average protein nutritional quality score of the carrier may have a DIAAS of at least 100, at least 110, at least 120, at least 130, at least 140, at least 150, at least 160, at least 170, at least 180, at least 190, or at least 200.

In some embodiments, the average protein nutritional quality score of the carrier or high-protein powder may have a DIAAS of about 100 to 110, or about 110 to 120, or about 120 to 130, or about 130 to 140, or about 140 to 150, or about 150 to 160, or about 160 to 170, or about 170 to 180, or about 180 to 190, or about 190 to 200.

In some embodiments, the average protein nutritional quality score of the carrier or high-protein powder may have a DIAAS of about 75 to 80, or about 80 to 85, or about 85 to 90, or about 90 to 92, or about 92 to 94, or about 94 to 96, or about 96 to 98, or about 98 to 100.

In some embodiments, the average protein nutritional quality score of the carrier or high-protein powder may have an IVDIAAS of at least 75, or at least 80, or at least 85, or at least 86, or at least 87, or at least 88, or at least 89, or at least 90, or at least 91, or at least 92, or at least 93, or at least 94, or at least 95, or at least 96, or at least 97, or at least 98, or at least 99 or at least 100.

In some embodiments, the average protein nutritional quality score of the carrier may have an IVDIAAS about 75 to 80, or about 80 to 85, or about 85 to 90, or about 90 to 92, or about 92 to 94, or about 94 to 96, or about 96 to 98, or about 98 to 100.

In some embodiments, the average protein nutritional quality score of the carrier or high-protein powder may have a IVDIAAS of at least 100, at least 110, at least 120, at least 130, at least 140, at least 150, at least 160, at least 170, at least 180, at least 190, or at least 200.

In some embodiments, the average protein nutritional quality score of the carrier or high-protein powder may have a IVDIAAS of about 100 to 110, or about 110 to 120, or about 120 to 130, or about 130 to 140, or about 140 to 150, or about 150 to 160, or about 160 to 170, or about 170 to 180, or about 180 to 190, or about 190 to 200.

Moisture Content

The moisture content of a composition impacts several factors related to the state and texture of the carrier, such as a broth, flour or dough. For example, the moisture content of a broth carrier is above 50%. The moisture content of a dough composition is about 15-50% and the moisture content of a flour composition may be less than 15%.

In some embodiments, the moisture content of the high protein powder or carrier of the disclosure is less than about 80%, about 75%, about 70%, about 65%, about 60%, about 55%, about 50%, about 45%, about 40%, about 35%, about 30%, about 25%, about 20%, about 15%, about 14%, about 13%, about 12%, about 11%, about 10%, about 9%, about 8%, about 7%, about 6%, about 5%, about 4%, about 3%, about 2% or about 1%.

In some embodiments, the moisture content of the high protein powder or carrier of the disclosure is about 1% to 2%, about 2% to 3%, about 3% to 4%, about 4% to 5%, about 5% to 6%, about 6% to 7%, about 7% to 8%, about 8% to 9%, about 9% to 10%, about 10% to 11%, about 11% to 12%, about 12% to 13%, about 13% to 14%, about 14% to 15%, about 15% to 20%, about 20% to 25%, about 25% to 30%, about 30% to 35%, about 35% to 40%, about 40% to 45%, about 45% to 50%, about 50% to 55%, about 55% to 60%, about 60% to 65%, about 65% to 70%, about 70% to 75%, or about 75% to 80%.

In some embodiments, the carrier is a combination of a dough composition, a broth composition, and/or a flour composition. For example, the combination may comprise 50% of a flour composition, 25% of a dough composition, and 25% of a broth composition.

In some embodiments, the composition may comprise at least 0.0001% of a dough composition, at least 1% of a dough composition, at least 1% of a dough composition, at least 5% of a dough composition, at least 10% of a dough composition, at least 15% of a dough composition, at least 20% of a dough composition, at least 25% of a dough composition, at least 30% of a dough composition, at least 35% of a dough composition, at least 40% of a dough composition, at least 45% of a dough composition, at least 50% of a dough composition, at least 55% of a dough composition, at least 60% of a dough composition, at least 65% of a dough composition, at least 70% of a dough composition, at least 75% of a dough composition, at least 80% of a dough composition, at least 85% of a dough composition, at least 90% of a dough composition, at least 95% of a dough composition, or at least 99% of a dough composition.

In some embodiments, the carrier may comprise about 0.0001% to 1% of a dough composition, about 1% to 5% of a dough composition, about 5% to 10% of a dough composition, about 10% to 15% of a dough composition, about 15% to 20% of a dough composition, about 20% to 25% of a dough composition, about 25% to 30% of a dough composition, about 30% to 35% of a dough composition, about 35% to 40% of a dough composition, about 40% to 45% of a dough composition, about 45% to 50% of a dough composition, about 50% to 55% of a dough composition, about 55% to 60% of a dough composition, about 60% to 65% of a dough composition, about 65% to 70% of a dough composition, about 70% to 75% of a dough composition, about 75% to 80% of a dough composition, about 80% to 85% of a dough composition, about 85% to 90% of a dough composition, about 90% to 95% of a dough composition, or about 95% to 99.9999% of a dough composition.

In some embodiments, the carrier may comprise at least 0.0001% of a flour composition, at least 1% of a flour composition, at least 1% of a flour composition, at least 5% of a flour composition, at least 10% of a flour composition, at least 15% of a flour composition, at least 20% of a flour composition, at least 25% of a flour composition, at least 30% of a flour composition, at least 35% of a flour composition, at least 40% of a flour composition, at least 45% of a flour composition, at least 50% of a flour composition, at least 55% of a flour composition, at least 60% of a flour composition, at least 65% of a flour composition, at least 70% of a flour composition, at least 75% of a flour composition, at least 80% of a flour composition, at least 85% of a flour composition, at least 90% of a flour composition, at least 95% of a flour composition, or at least 99% of a flour composition.

In some embodiments, the carrier may comprise about 0.0001% to 1% of a flour composition, about 1% to 5% of a flour composition, about 5% to 10% of a flour composition, about 10% to 15% of a flour composition, about 15% to 20% of a flour composition, about 20% to 25% of a flour composition, about 25% to 30% of a flour composition, about 30% to 35% of a flour composition, about 35% to 40% of a flour composition, about 40% to 45% of a flour composition, about 45% to 50% of a flour composition, about 50% to 55% of a flour composition, about 55% to 60% of a flour composition, about 60% to 65% of a flour composition, about 65% to 70% of a flour composition, about 70% to 75% of a flour composition, about 75% to 80% of a flour composition, about 80% to 85% of a flour composition, about 85% to 90% of a flour composition, about 90% to 95% of a flour composition, or about 95% to 99.9999% of a flour composition.

In some embodiments, the carrier may comprise at least 0.0001% of a broth composition, at least 1% of a broth composition, at least 1% of a broth composition, at least 5% of a broth composition, at least 10% of a broth composition, at least 15% of a broth composition, at least 20% of a broth composition, at least 25% of a broth composition, at least 30% of a broth composition, at least 35% of a broth composition, at least 40% of a broth composition, at least 45% of a broth composition, at least 50% of a broth composition, at least 55% of a broth composition, at least 60% of a broth composition, at least 65% of a broth composition, at least 70% of a broth composition, at least 75% of a broth composition, at least 80% of a broth composition, at least 85% of a broth composition, at least 90% of a broth composition, at least 95% of a broth composition, or at least 99% of a broth composition.

In some embodiments, the carrier may comprise about 0.0001% to 1% of a broth composition, about 1% to 5% of a broth composition, about 5% to 10% of a broth composition, about 10% to 15% of a broth composition, about 15% to 20% of a broth composition, about 20% to 25% of a broth composition, about 25% to 30% of a broth composition, about 30% to 35% of a broth composition, about 35% to 40% of a broth composition, about 40% to 45% of a broth composition, about 45% to 50% of a broth composition, about 50% to 55% of a broth composition, about 55% to 60% of a broth composition, about 60% to 65% of a broth composition, about 65% to 70% of a broth composition, about 70% to 75% of a broth composition, about 75% to 80% of a broth composition, about 80% to 85% of a broth composition, about 85% to 90% of a broth composition, about 90% to 95% of a broth composition, or about 95% to 99.9999% of a broth composition.

Generic Compositions

As referred to herein, a “generic composition” shall be a standard food composition or food item that is known in the art, which can include food compositions that comprise a carrier and a filler; however, the carrier is not or is different than a high-protein carrier of the present disclosure. Examples include but are not limited to: a sandwich with a typical or standard bun (i.e., carrier) or bread (i.e., carrier) and ingredients (i.e., filler) bought from a store, or a sandwich provided by currently existing restaurants or providers. Such examples are expected to have nutritional ranges as are currently known in the art for food compositions based on standard components and ingredients that are currently known in the art.

In some embodiments, the carrier of the current disclosure comprises more calories from protein than a generic composition. In some embodiments, the carrier of the current disclosure comprises at least 10%, at least 20%, at least 30%, at least 40%, at least 50%, at least 60%, at least 70%, at least 80%, at least 90%, at least 100%, at least 110%, at least 120%, at least 130%, at least 140%, at least 150%, at least 160%, at least 170%, at least 180%, at least 190%, at least 200%, at least 210%, at least 120%, at least 230%, at least 240%, at least 250%, at least 260%, at least 270%, at least 280%, at least 290%, at least 300%, at least 310%, at least 320%, at least 330%, at least 340%, at least 350%, at least 360%, at least 370%, at least 380%, at least 390%, at least 400%, at least 410%, at least 420%, at least 430%, at least 440%, at least 450%, at least 460%, at least 470%, at least 480%, at least 490%, at least 500%, at least 750%, or at least 1000% more calories from protein than a generic composition.

In some embodiments, the carrier of the current disclosure comprises about 10% to about 20%, about 20% to about 30%, about 30% to about 40%, about 40% to about 50%, about 50% to about 60%, about 60% to about 70%, about 70% to about 80%, about 80% to about 90%, about 90% to about 100%, about 100% to about 110%, about 110% to about 120%, about 120% to about 130%, about 130% to about 140%, about 140% to about 150%, about 150% to about 160%, about 160% to about 170%, about 170% to about 180%, about 180% to about 190%, about 190% to about 200%, about 200% to about 210%, about 210% to about 220%, about 220% to about 230%, about 230% to about 240%, about 240% to about 250%, about 250% to about 260%, about 260% to about 270%, about 270% to about 280%, about 280% to about 290%, about 290% to about 300%, about 300% to about 310%, about 310% to about 320%, about 320% to about 330%, about 330% to about 340%, about 340% to about 350%, about 350% to about 360%, about 360% to about 370%, about 370% to about 380%, about 380% to about 390%, about 390% to about 400%, about 400% to about 410%, about 410% to about 420%, about 420% to about 430%, about 430% to about 440%, about 440% to about 450%, about 450% to about 460%, about 460% to about 470%, about 470% to about 480%, about 480% to about 490%, about 490% to about 500%, about 500% to about 750%, or about 750% to about 1000% more calories from protein than a generic composition.

In some embodiments, the carrier of the current disclosure comprises fewer calories from carbohydrates than a generic composition. In some embodiments, the carrier of the current disclosure comprises at least 10%, at least 20%, at least 30%, at least 40%, at least 50%, at least 60%, at least 70%, at least 80%, at least 90%, or at least 100% fewer calories from carbohydrates than a generic composition.

In some embodiments, the carrier of the current disclosure comprises between 10% to 20%, between 20% to 30%, between 30% to 40%, between 40% to 50%, between 50% to 60%, between 60% to 70%, between 70% to 80%, between 80% to 90%, or between 90% to 100% fewer calories from carbohydrates than a generic composition.

In some embodiments, the calories from fat of the carrier of the present disclosure are similar to a generic composition while maintaining higher protein. In some embodiments, similar calories from fat of the carrier of the present disclosure are less than about 50%, less than about 40%, less than about 30%, less than about 20%, less than about 10%, less than about 5%, or less than about 1% different compared to a generic composition while maintaining higher protein.

In some embodiments, similar calories from fat of the carrier of the present disclosure are less than between 1% to 5%, less than between 5% to 10%, less than between 10% to 20%, less than between 20% to 30%, less than between 30% to 40%, or less than between 40% to 50% different compared to a generic composition while maintaining higher protein.

In some embodiments, the carrier of the present disclosure comprises both L-amino acids and D-amino acids.

In some embodiments, the carrier may comprise at least 0.0001% L-amino acids, at least 1% L-amino acids, at least 1% L-amino acids, at least 5% L-amino acids, at least 10% L-amino acids, at least 15% L-amino acids, at least 20% L-amino acids, at least 25% L-amino acids, at least 30% L-amino acids, at least 35% L-amino acids, at least 40% L-amino acids, at least 45% L-amino acids, at least 50% L-amino acids, at least 55% L-amino acids, at least 60% L-amino acids, at least 65% L-amino acids, at least 70% L-amino acids, at least 75% L-amino acids, at least 80% L-amino acids, at least 85% L-amino acids, at least 90% L-amino acids, at least 95% L-amino acids, or at least 99% L-amino acids.

In some embodiments, the carrier may comprise about 0.0001% to 1% L-amino acids, about 1% to 5% L-amino acids, about 5% to 10% L-amino acids, about 10% to 15% L-amino acids, about 15% to 20% L-amino acids, about 20% to 25% L-amino acids, about 25% to 30% L-amino acids, about 30% to 35% L-amino acids, about 35% to 40% L-amino acids, about 40% to 45% L-amino acids, about 45% to 50% L-amino acids, about 50% to 55% L-amino acids, about 55% to 60% L-amino acids, about 60% to 65% L-amino acids, about 65% to 70% L-amino acids, about 70% to 75% L-amino acids, about 75% to 80% L-amino acids, about 80% to 85% L-amino acids, about 85% to 90% L-amino acids, about 90% to 95% L-amino acids, or about 95% to 99.99990% L-amino acids.

In some embodiments, the carrier may comprise at least 0.0001% D-amino acids, at least 1% D-amino acids, at least 1% D-amino acids, at least 5% D-amino acids, at least 10% D-amino acids, at least 15% D-amino acids, at least 20% D-amino acids, at least 25% D-amino acids, at least 30% D-amino acids, at least 35% D-amino acids, at least 40% D-amino acids, at least 45% D-amino acids, at least 50% D-amino acids, at least 55% D-amino acids, at least 60% D-amino acids, at least 65% D-amino acids, at least 70% D-amino acids, at least 75% D-amino acids, at least 80% D-amino acids, at least 85% D-amino acids, at least 90% D-amino acids, at least 95% D-amino acids, or at least 99% D-amino acids.

In some embodiments, the carrier may comprise about 0.0001% to 1% D-amino acids, about 1% to 5% D-amino acids, about 5% to 10% D-amino acids, about 10% to 15% D-amino acids, about 15% to 20% D-amino acids, about 20% to 25% D-amino acids, about 25% to 30% D-amino acids, about 30% to 35% D-amino acids, about 35% to 40% D-amino acids, about 40% to 45% D-amino acids, about 45% to 50% D-amino acids, about 50% to 55% D-amino acids, about 55% to 60% D-amino acids, about 60% to 65% D-amino acids, about 65% to 70% D-amino acids, about 70% to 75% D-amino acids, about 75% to 80% D-amino acids, about 80% to 85% D-amino acids, about 85% to 90% D-amino acids, about 90% to 95% D-amino acids, or about 95% to 99.99990% D-amino acids.

In some embodiments, the allergens of the carrier of the disclosure are reduced by about 100%, about 90%, about 80, about 70%, about 60%, about 55%, about 50%, about 45%, about 40%, about 35%, about 30%, about 25%, about 20%, about 15%, about 14%, about 13%, about 12%, about 11%, about 10%, about 9%, about 8%, about 7%, about 6%, about 5%, about 4%, about 3%, about 2% or about 1%.

In some embodiments, the allergens of the carrier of the disclosure are reduced between 1% to 2%, between 2% to 3%, between 3% to 4%, between 4% to 5%, between 5% to 6%, between 6% to 7%, between 7% to 8%, between 8% to 9%, between 9% to 10%, between 10% to 11%, between 11% to 12%, between 12% to 13%, between 13% to 14%, between 14% to 15%, between 15% to 20%, between 20% to 25%, between 25% to 30%, between 30% to 35%, between 35% to 40%, between 40% to 45%, between 45% to 50%, between 50% to 55%, or between 55% to 60%, between 60% to 65%, between 65% to 70%, between 70% to 75%, between 75% to 80%, between 80% to 85%, between 85% to 90%, between 90% to 95%, or between 95% to 100%.

In some embodiments, a carrier produced by the methods disclosed herein have a lower glycemic index compared to the compositions before the method.

In some embodiments, a carrier produced by the methods disclosed herein have a lower glycemic index at least 0.0001% lower, at least 1% lower, at least 1% lower, at least 5% lower, at least 10% lower, at least 15% lower, at least 20% lower, at least 25% lower, at least 30% lower, at least 35% lower, at least 40% lower, at least 45% lower, at least 50% lower, at least 55% lower, at least 60% lower, at least 65% lower, at least 70% lower, at least 75% lower, at least 80% lower, at least 85% lower, at least 90% lower, at least 95% lower, or 100% lower compared to the compositions before the method.

In some embodiments, a carrier produced by the methods disclosed herein have a glycemic index about 0.0001% to 1% lower, about 1% to 5% lower, about 5% to 10% lower, about 10% to 15% lower, about 15% to 20% lower, about 20% to 25% lower, about 25% to 30% lower, about 30% to 35% lower, about 35% to 40% lower, about 40% to 45% lower, about 45% to 50% lower, about 50% to 55% lower, about 55% to 60% lower, about 60% to 65% lower, about 65% to 70% lower, about 70% to 75% lower, about 75% to 80% lower, about 80% to 85% lower, about 85% to 90% lower, about 90% to 95% lower, or about 95% to 100% lower compared to the compositions before the method.

In Silico Methods for Improving a Carrier of the Present Disclosure

In some embodiments, the present disclosure provides in silico methods to increase the protein nutritional quality score of a carrier for use in a food composition provided herein.

In some embodiments, the in silico method uses a mixture prediction algorithm to increase the average protein nutritional quality score of the carrier by mixing one composition with a lower the protein nutritional quality score and one composition with a higher protein nutritional quality score.

In some embodiments, the composition with a higher protein nutritional quality score is identified by the method.

In some embodiments, the method identifies a species of yeast to increase the protein nutritional quality score of the carrier.

In some embodiments, the method identifies a species of bacteria to increase the protein nutritional quality score of the carrier.

In some embodiments, the method identifies a species of fungi to increase the protein nutritional quality score of the carrier.

In some embodiments, the method identifies a species of plant to increase the protein nutritional quality score of the carrier.

In some embodiments, the method identifies an unknown organism to increase the protein nutritional quality score of the carrier.

In some embodiments, the method identifies individual proteins to increase the protein nutritional quality score of the carrier. The protein nutritional quality score of the carrier identified by the in silico method provided herein can be any of the protein nutritional quality scores as provided herein.

### Filler

In some embodiments, a filler for use in a food composition as provided herein is disposed, dispensed or deposited on the carrier. In some embodiments, a filler as provided herein is disposed, dispensed or deposited on top of the carrier. In some embodiments, a filler as provided herein is disposed, dispensed or deposited between the two carriers. In some embodiments, a filler as provided herein is disposed, dispensed or deposited inside the carrier. In some embodiments, the carrier is sealed around the filler.

In some embodiments, the filler for use in a food composition as provided herein is not an animal product. In some embodiments, the filler for use in a food composition as provided herein is an animal product. In some embodiments, the filler for use in a food composition as provided herein is a plant-based product. In some embodiments, the filler for use in a food composition as provided herein is both an animal product and a plant-based product. The animal product can be meat, milk obtained from an animal or a cheese produced from an animal product. In some embodiments, the filler for use in a food composition as provided herein is a water-in-oil based emulsion or an oil-in-water emulsion. In some embodiments, the filler is a vegan filler. In some embodiments, the filler comprises cheese. In some embodiments, the filler comprises avocado. In some embodiments, the filler comprises potato. In some embodiments, the filler comprises fruit. In some embodiments, the filler comprises cucumber.

In some embodiments, the filler may be a ground meat replica. In some embodiments, the ground meat replica comprises (a) an iron salt with one or more flavor precursors and an optional fat; (b) a mixture of one or more flavor compounds; (c) an isolated plant protein, an optional edible fibrous component, and the mixture from step (b); (d) a fat, the fat optionally containing a flavoring agent and/or an isolated plant protein; and (e) the dough of step (d) with a carbohydrate-based gel, an optional binding agent, an iron salt, an optional highly conjugated heterocyclic ring complexed to an iron ion, and one or more optional flavoring agents to make the ground meat replica.

In some embodiments, a highly conjugated heterocyclic ring complexed to an iron ion can be combined with the iron salt, the one or more flavor precursors, and the fat before heating the mixture. In some embodiments, the iron salt can be iron gluconate, iron chloride, iron oxalate, iron nitrate, iron citrate, iron ascorbate, ferrous sulfate, ferric pyrophosphate, or any other aqueous soluble salt.

In some embodiments, the heme-containing protein can be a non-animal heme-containing protein, such as a plant-derived heme-containing protein (e.g., leghemoglobin). In some embodiments, the heme-containing protein can be isolated or isolated and purified.

In some embodiments, the one or more flavor precursors can be a sugar, a sugar alcohol, a sugar acid, a sugar derivative, an oil, a free fatty acid, an amino acid or derivative thereof, a nucleoside, a nucleotide, a vitamin, an acid, a peptide, a phospholipid, a protein hydrolysate, a yeast extract, or a mixture thereof. For example, the flavor precursor can be selected from the group consisting of glucose, fructose, ribose, arabinose, glucose-6-phosphate, fructose 6-phosphate, fructose 1,6-diphosphate, inositol, maltose, sucrose, maltodextrin, glycogen, nucleotide-bound sugars, molasses, a phospholipid, a lecithin, inosine, inosine monophosphate (IMP), guanosine monophosphate (GMP), pyrazine, adenosine monophosphate (AMP), lactic acid, succinic acid, glycolic acid, thiamine, creatine, pyrophosphate, vegetable oil, algal oil, sunflower oil, corn oil, soybean oil, palm fruit oil, palm kernel oil, safflower oil, flaxseed oil, rice bran oil, cottonseed oil, olive oil, sunflower oil, canola oil, flaxseed oil, coconut oil, mango oil, a free fatty acid, cysteine, methionine, isoleucine, leucine, lysine, phenylalanine, threonine, tryptophan, valine, arginine, histidine, alanine, asparagine, aspartate, glutamate, glutamine, glycine, proline, serine, tyrosine, glutathione, an amino acid derivative, urea, pantothenic acid, ornithine, niacin, glycerol, citrulline, taurine, biotin, borage oil, fungal oil, blackcurrant oil, betaine, beta carotene, B-vitamins, N-Acetyl L-cysteine, iron glutamate and a peptone, or mixtures thereof.

In some embodiments, the filler may comprise an isolated plant protein. In some embodiments, the isolated plant protein in the dough can include wheat gluten, a dehydrin protein, an albumin, a globulin, or a zein, or mixtures thereof.

In some embodiments, the filler may can include plant fibers from carrot, bamboo, pea, broccoli, potato, sweet potato, corn, whole grains, alfalfa, kale, celery, celery root, parsley, cabbage, zucchini, green beans, kidney beans, black beans, red beans, white beans, beets, cauliflower, nuts, apple skins, oats, wheat, or psyllium, or a mixture thereof.

In some embodiments, the filler may include an extruded mixture of isolated plant proteins. The extruded mixture can contain wheat gluten and soy protein isolate, and optionally can further contain a flavoring agent (e.g., a flavoring such as yeast extract, a protein hydrolysate, or an oil; a flavor compound; or a flavor precursor). In some embodiments, the edible fibrous component can be a solution-spun protein fiber (e.g., a solution-spun protein fiber containing a prolamin such as corn zein, pea prolamin, kafirin, secalin, hordein, avenin, or a mixture thereof).

In some embodiments, the filler may be a non-animal fat, an animal fat, or a mixture of non-animal and animal fat. The fat can be an algal oil, a fungal oil, corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut oil, babassu oil, shea butter, mango butter, cocoa butter, wheat germ oil, borage oil, black currant oil, sea-buckhorn oil, macadamia oil, saw palmetto oil, conjugated linoleic oil, arachidonic acid enriched oil, docosahexaenoic acid (DHA) enriched oil, eicosapentaenoic acid (EPA) enriched oil, palm stearic acid, sea-buckhorn berry oil, macadamia oil, saw palmetto oil, or rice bran oil; or margarine or other hydrogenated fats. In some embodiments, for example, the fat is algal oil. The fat can contain the flavoring agent and/or the isolated plant protein (e.g., a conglycinin protein).

### Digestibility

Digestibility factors can be measured by a variety of methods and represent the true ability of an organism to process the food material as it passes through the intestines. It may often be measured in animals after passage through the small intestine or through the animal (fecal matter analysis). Digestibility may or may not be affected by processing, drying, baking, or other downstream processes. Digestibility factors known for comparable materials are used. For example, a comparable material, mycoprotein, is listed as having a digestibility of 0.86 (86%) (Edwards & Cummings, “The protein quality of mycoprotein”, Proceedings of the Nutrition Society, 2010, 69). We multiply the least represented AAS score by the digestibility factor to arrive at the PDCAAS.

In some embodiments, a digestibility from mycoprotein or other factors derived from literature studies is used. In some embodiments, the digestibility factor may be from yeast-derived single cell protein, bacterial single cell protein, other single cell protein, plant-derived proteins, milk, whey, casein, or other protein standards known in the art. In some embodiments the digestibility factor may be derived from laboratory (in vitro) experiments or estimated using in vitro or in silico models.

### Protein Nutritional Quality

A microbial protein used in a carrier and/or high-protein powder as used herein may be designed to have a certain amino acid profile. Various methods may be used to design the target amino acid profile, to determine the amino acid profile, and to calculate the distance between the actual amino acid profile and a target profile or profile of a common food source.

In some embodiments, the Euclidean distance is used to calculate the amino acid distribution of an organism as compared to a target distribution.

The Euclidean distance of a given amino acid distribution (p) to a target distribution (t) is calculated using the following formula Distance=\sqrt{Σ_{iεAA}(pᵢ−tᵢ)²}, where AA={H, I, L, K, SAA, AAA, T, W, V, A, R, N, D, Q, E, G, P, and S}, pᵢ is the fraction of amino acid in the given protein distribution, and t is the fraction of amino acid in the target distribution. This metric corresponds to the square root of the sum of the squared error for each amino acid (EAAs, CEAAs, and NEAAs), and measures the percent distance between a given and target amino acid distribution.

In some embodiments, the Euclidian distance of the amino acid distribution profile of a nutritive protein or fragment thereof is determined relative to a target amino acid distribution profile. In some embodiments the target amino acid distribution profile comprises a target distribution for EAAs. In some embodiments the target amino acid distribution profile comprises a target distribution for NEAAs. In some embodiments the target amino acid distribution profile comprises a target distribution for CEAAs. In some embodiments the target amino acid distribution profile comprises a target distribution for at least two of EAAs, CEAAs, and NEAAs. In some embodiments the target amino acid distribution profile comprises a target distribution for EAAs, CEAAs, and NEAAs. In some embodiments the target amino acid distribution profile of EAAs and CEAAs is a PDCAAS score. In some embodiments the target amino acid distribution profile of NEAAs is the NEAA amino acid distribution profile of NEAAs present in a benchmark dietary protein source.

In some embodiments the target amino acid distribution profile of EAAs and CEAAs is a PDCAAS score of at least about 1.4, at least about 1.5, at least about 1.6, at least about 1.7, at least about 1.8, at least about 1.9, at least about 2.0, at least about 2.1, at least about 2.2, at least about 2.3, at least about 2.4, at least about 2.5, at least about 2.6, at least about 2.7, at least about 2.8, at least about 2.9, at least about 3.0, at least about 3.1, at least about 3.2, at least about 3.3, at least about 3.4, at least about 3.5, or about 3.6. In some embodiments the target amino acid distribution profile of EAAs and CEAAs is a PDCAAS score of at least about 1.4 to about 1.6, from about 1.4 to about 1.8, from about 1.4 to about 2.0, from about 1.4 to about 2.2, from about 1.4 to about 2.4, from about 1.4 to about 2.6, from about 1.4 to about 2.8, from about 1.4 to about 3.0, from about 1.4 to about 3.2, from about 1.4 to about 3.4, or from about 1.4 to about 3.6.

In some embodiments, the target amino acid distribution profile comprises at least 50% by weight EAAs. In some embodiments the target amino acid distribution profile comprises at least 55% by weight EAAs, at least 60% by weight EAAs, at least 65% by weight EAAs, at least 70% by weight EAAs, at least by weight 75% EAAs, at least 80% by weight EAAs, at least 85% by weight EAAs, at least 90% by weight EAAs, or at least 95% by weight EAAs, at least 96% by weight EAAs, at least 97% by weight EAAs, at least 98% by weight EAAs, at least 99% by weight EAAs, or 100% EAAs. In some embodiments the target amino acid distribution profile comprises from 50 to 100% by weight EAAs, from 60 to 100% by weight EAAs, from 70 to 100% by weight EAAs, from 80 to 90% by weight EAAs, from 60 to 90% by weight EAAs, from 60 to 80% by weight EAAs, from 70 to 90% by weight EAAs, from 60 to 70% by weight EAAs, from 70 to 80% by weight EAAs, from 80 to 90% by weight EAAs, and from 90 to 100% by weight EAAs. In some embodiments the target amino acid distribution profile comprises from 90% to 100% EAAs and CEAAs (that is, the combined fraction of essential amino acids and conditionally essential amino acids in the nutritive proteins is from 90% to 100%.

In some embodiments, a machine learning system, such as linear regression, polynomial regression, decision tree, and random forest, can be continuously trained over time. It can derive from the test result for confirming or negating a score and be incorporated to training data. The training data can improve determination of a microbial organism's protein nutritional quality score generated by the machine learning system.

In some embodiments, these calculated scores allow for calculation of PDCAAS and DIAAS for many organisms, ranging from individual proteins, bacteria, lower eukaryotes such as yeast, through higher plants. These scores allow for determination of ideal organisms used to create protein for optimal nutritional quality.

In some embodiments, these calculated scores allow for calculation of IVPDCAAS and IVDIAAS for many organisms, ranging from an individual protein, bacteria, lower eukaryotes such as yeast, through higher plants. These scores allow for determination of ideal organisms used to create protein for optimal nutritional quality.

In some embodiments, these calculated scores allow for calculation of PDCAAS and DIAAS for many organisms, ranging from an individual protein, bacteria, lower eukaryotes such as yeast, through higher plants. These scores allow for determination of a microorganism protein nutritional quality score.

In some embodiments, these calculated scores allow for calculation of IVPDCAAS and IVDIAAS for many organisms, ranging from an individual protein, bacteria, lower eukaryotes such as yeast, through higher plants. These scores allow for determination of a microorganism protein nutritional quality score.

In some embodiments, the microorganism protein nutritional quality score may have a PDCAAS of at least 0.75, or at least 0.80, or at least 0.85, or at least 0.86, or at least 0.87, or at least 0.88, or at least 0.89, or at least 0.90, or at least 0.91, or at least 0.92, or at least 0.93, or at least 0.94, or at least 0.95, or at least 0.96, or at least 0.97, or at least 0.98, or at least 0.99 or at least 1.

In some embodiments, the microorganism protein nutritional quality score may have an PDCAAS of at least 1, or at least 1.25, or at least 1.5, or at least 1.75, or at least 2 or at least 2.25, or at least 2.5, or at least 2.75, or at least 3, or at least 3.25, or at least 3.5, or at least 3.6.

In some embodiments, the microorganism protein nutritional quality score may have a PDCAAS of about 0.75 to 0.80, or about 0.80 to 0.85, or about 0.85 to 0.9, or about 0.90 to 0.92, or about 0.92 to 0.94, or about 0.94 to 0.96, or about 0.96 to 0.98, or about 0.98 to 1.

In some embodiments, the microorganism protein nutritional quality score may have a PDCAAS of about 1 to 1.25, or about 1.25 to 1.50, or about 1.50 to 1.75, or about 1.75 to 2, or about 2 to 2.25, or about 2.25 to 2.50, or about 2.50 to 2.75, or about 2.75 to 3, or about 3 to 3.25, or about 3.25 to 3.50, or about 3.50 to 3.6.

In some embodiments, the microorganism protein nutritional quality score may have an IVPDCAAS of at least 0.75, or at least 0.80, or at least 0.85, or at least 0.86, or at least 0.87, or at least 0.88, or at least 0.89, or at least 0.90, or at least 0.91, or at least 0.92, or at least 0.93, or at least 0.94, or at least 0.95, or at least 0.96, or at least 0.97, or at least 0.98, or at least 0.99 or at least 1.

In some embodiments, the microorganism protein nutritional quality score may have an IVPDCAAS of at least 1, or at least 1.25, or at least 1.5, or at least 1.75, or at least 2 or at least 2.25, or at least 2.5, or at least 2.75, or at least 3, or at least 3.25, or at least 3.5, or at least 3.6.

In some embodiments, the microorganism protein nutritional quality score may have an IVPDCAAS of about 0.75 to 0.80, or about 0.80 to 0.85, or about 0.85 to 0.9, or about 0.90 to 0.92, or about 0.92 to 0.94, or about 0.94 to 0.96, or about 0.96 to 0.98, or about 0.98 to 1.

In some embodiments, the microorganism protein nutritional quality score may have a IVPDCAAS of about 1 to 1.25, or about 1.25 to 1.50, or about 1.50 to 1.75, or about 1.75 to 2, or about 2 to 2.25, or about 2.25 to 2.50, or about 2.50 to 2.75, or about 2.75 to 3, or about 3 to 3.25, or about 3.25 to 3.50, or about 3.50 to 3.6.

In some embodiments, the microorganism protein nutritional quality score may have a DIAAS of at least 75, or at least 80, or at least 85, or at least 86, or at least 87, or at least 88, or at least 89, or at least 90, or at least 91, or at least 92, or at least 93, or at least 94, or at least 95, or at least 96, or at least 97, or at least 98, or at least 99 or at least 100.

In some embodiments, the microorganism protein nutritional quality score may have a DIAAS of at least 100, at least 110, at least 120, at least 130, at least 140, at least 150, at least 160, at least 170, at least 180, at least 190, or at least 200.

In some embodiments, the microorganism protein nutritional quality score may have a DIAAS of about 100 to 110, or about 110 to 120, or about 120 to 130, or about 130 to 140, or about 140 to 150, or about 150 to 160, or about 160 to 170, or about 170 to 180, or about 180 to 190, or about 190 to 200.

In some embodiments, the microorganism protein nutritional quality score may have a DIAAS about 75 to 80, or about 80 to 85, or about 85 to 90, or about 90 to 92, or about 92 to 94, or about 94 to 96, or about 96 to 98, or about 98 to 100.

In some embodiments, the microorganism protein nutritional quality score may have an IVDIAAS of at least 75, or at least 80, or at least 85, or at least 86, or at least 87, or at least 88, or at least 89, or at least 90, or at least 91, or at least 92, or at least 93, or at least 94, or at least 95, or at least 96, or at least 97, or at least 98, or at least 99 or at least 100.

In some embodiments, the microorganism protein nutritional quality score may have an IVDIAAS about 75 to 80, or about 80 to 85, or about 85 to 90, or about 90 to 92, or about 92 to 94, or about 94 to 96, or about 96 to 98, or about 98 to 100.

In some embodiments, the microorganism protein nutritional quality score may have a IVDIAAS of at least 100, at least 110, at least 120, at least 130, at least 140, at least 150, at least 160, at least 170, at least 180, at least 190, or at least 200.

In some embodiments, the microorganism protein nutritional quality score may have a IVDIAAS of about 100 to 110, or about 110 to 120, or about 120 to 130, or about 130 to 140, or about 140 to 150, or about 150 to 160, or about 160 to 170, or about 170 to 180, or about 180 to 190, or about 190 to 200.

In some embodiments, the nutritive protein comprises an individual protein sequence that comprises at least 20 amino acids. In some embodiments the individual protein sequence comprises at least 30 amino acids, at least 40 amino acids, at least 50 amino acids, at least 60 amino acids, at least 70 amino acids, at least 80 amino acids, at least 90 amino acids, at least 100 amino acids, at least 110 amino acids, at least 120 amino acids, at least 130 amino acids, at least 140 amino acids, at least 150 amino acids, at least 160 amino acids, at least 170 amino acids, at least 180 amino acids, at least 190 amino acids, at least 200 amino acids, at least 300 amino acids, at least 400 amino acids, at least 500 amino acids, at least 600 amino acids, at least 700 amino acids, at least 800 amino acids, at least 900 amino acids, or at least 1,000 amino acids. In some embodiments the individual protein sequence comprises from 20 to 50 amino acids, from 20 to 75 amino acids, from 20 to 100 amino acids, from 30 to 100 amino acids, from 40 to 100 amino acids, from 50 to 100 amino acids, from 50 to 200 amino acids, from 100 to 200 amino acids, from 200 to 300 amino acids, from 300 to 400 amino acids, or from 400 to 500 amino acids.

In some embodiments the individual protein sequence comprises at least 50% by weight EAAs. In some embodiments the individual protein sequence comprises at least 55% by weight EAAs, at least 60% by weight EAAs, at least 65% by weight EAAs, at least 70% by weight EAAs, at least by weight 75% EAAs, at least 80% by weight EAAs, at least 85% by weight EAAs, at least 90% by weight EAAs, or at least 95% by weight EAAs, at least 96% by weight EAAs, at least 97% by weight EAAs, at least 98% by weight EAAs, at least 99% by weight EAAs, or 100% EAAs.

In some embodiments the individual protein sequence comprises from 50 to 100% by weight EAAs, from 60 to 100% by weight EAAs, from 70 to 100% by weight EAAs, from 80 to 90% by weight EAAs, from 60 to 90% by weight EAAs, from 60 to 80% by weight EAAs, from 70 to 90% by weight EAAs, from 60 to 70% by weight EAAs, from 70 to 80% by weight EAAs, from 80 to 90% by weight EAAs, and from 90 to 100% by weight EAAs. In some embodiments the individual protein sequence comprises from 90% to 100% EAAs and CEAAs. In some embodiments the individual protein sequence comprises 100% EAAs and CEAAs.

### Human Use Microbes

Humans have used microbes for millennia in the production of fermented foods. As a result of their history as harmless, these microorganisms are considered as GRAS (Generally Regarded As Safe) for many applications, including human and animal consumption.

In some embodiments, the microorganisms of the disclosure include, but are not limited to, yeasts such as Saccharomyces cerevisiae, molds such as Aspergillus, Rhizopus, Mucor, and bacteria such as Lactobacillus. Additional examples of suitable probiotic microorganisms are: Aspergillus niger, A. oryzae, Bacillus coagulans, B. lentus, B. lichenformis, B. mesentericus, B. pumilus, B. subtilis, B. natto, Bifidobacterium adolescentis, B. animalis, B. breve, B. bifidum, B. infantis, B. lactis, B. longum, B. longum BB536, B. longum AH 1206 (NCIMB: 41382), B. breve AH1205 (NCIMB: 41387), B. infantis 35624 (NCIMB: 41003), B. longum AH1714 (NCIMB 41676), B. animalis subsp. lactis BB-12 (DSM No. 10140), B. pseudolongum, B. thermophilum, Candida pintolopesii, Clostridium butyricum, Enterococcus cremoris, E. diacetylactis, E faecium, E. intermedius, E. lactis, E. muntdi, E. thermophilus, Lactobacillus acidophilus, L. alimentarius, L. amylovorus, L. crispatus, L. brevis, L. case, L. curvatus, L. cellobiosus, L. delbrueckii ss. bulgaricus, L. farciminis, L. fermentum, L. gasseri, L. helveticus, L. lactis, L. plantarum, L. johnsonii, L. reuteri, L. rhamnosus, Lactobacillus rhamnosus GG (ATCC number 53103), L. sakei, L. salivarius and any combination thereof.

### Allergens in Plant Biomass

A plant allergen is an allergen that includes one or more compounds present in a plant. Plant allergens that may be removed in the present include: wheat allergens such as rTri a 19 ω-5 gliadin, wheat complete allergen, wheat gliadin, rTri a 14LTP, etc.; Actinidia chinensis allergens, such as rAct d 8PR-10, Actinidia chinensis complete allergen, etc.; celery allergens such as rApi g 1.01PR-10, rPhl p 12, celery complete allergen, CCD MUXF3 derived from bromelain, etc.; soybean allergens such as rGly m 4PR-10, soybean complete allergen, nGly m 5 β-conglycinin, nGly m 6 glycinin, etc.; stone fruit allergens such as f419, f420, f421, f95, f242, o214rPru p 1PR-10, rPru p 3LTP, stone fruit primary complete allergen, CCD MUXF3 derived from bromelain, etc.; oat allergens such as oat component allergen, oat complete allergen, etc.; sesame allergens include sesame seed component allergens, sesame seed complete allergens, and the like.

A nut allergen is an allergen comprising one or more compounds present in a nut (such as a dried fruit comprising an edible nut or meat enclosed within a woody or leather shell). Nut allergens of interest include, but are not limited to: peanut allergens, such as rAra h 1, rAra h2, rAra h 3, rAra h 8PR-10, rAra h 9LTP, peanut complete allergens, referring to all possible antigenic components of a given food protein, and the like; brazil nut allergens such as rBer el, Brazil nut complete allergens, and the like; hazelnut allergens such as rcora a 1PR-10, rcora a 8LTP, hazelnut full allergen, nCor a 9, rCor a 14, etc.; walnut allergens such as rJug r 1, rJug r 3LTP, walnut complete allergens, etc.; (ii) a cashew nut allergen; pistachio nut allergens, such as pistachio nut component allergens, pistachio nut complete allergens, and the like; pecan allergens, such as pecan component allergens, pecan complete allergens, and the like; a tree nut component allergen packet, such as one or more allergens from cashew nuts, walnuts, hazelnuts, and/or brazil nuts.

### L-Amino Acids and D-Amino Acids

Amino acids are made from amine (—NH₂) and carboxylic acid (—COOH) functional groups, along with a side-chain specific to each type of amino acid. All amino acids (except glycine) can occur in two isomeric forms, because of the possibility of forming two different enantiomers (stereoisomers) around the central carbon atom. By convention, these stereoisomers are referred to as “L-” and “D-” forms, analogous to left-handed and right-handed configurations. Only L-amino acids are manufactured in cells and incorporated into proteins, whereas D-amino acids are more plentifully produced by microorganisms. The L-enantiomers of amino acids are widely assumed to account for most of their biological effects, including signaling, transporter-mediated protein interactions, and as a metabolic substrate. In mammals D-amino acids are believed to play a role in neuronal signaling. For example, D-serine is a potent ligand for the glycine binding site on the N-methyl-D-aspartate (NMDA) receptor. Other D-amino acids are present in the brain. For example, D-leucine is present in the hippocampus and pineal gland, D-aspartic acid is present in the pituitary gland, and D-alanine is present in the pituitary gland. Some studies have suggested that consumption of D-amino acids, such as Hartman et al. Neurobiology of disease vol. 82 (2015): 46-53, may decrease seizure activity.

### Glycemic Index

The glycemic index (GI) is a measure of the blood glucose rising property of food. It is determined by analyzing the blood glucose levels in regular intervals for a 2-3 hour period after intake of the test food and a reference food which, by convention, is either white bread or glucose.

The term “glycemic index” of a food refers to the incremental area under the blood glucose response curve of that food expressed in percent of the response to the reference food expressed as a percentage of the response to the reference food (with the same amount of available carbohydrate) which, by convention, is fresh white bread or glucose. As there exists a close association between the glycemic and insulinemic response to food, in the present application the term “glycemic index” encompasses the term “insulinemic index”. Correspondingly, the terms “low-”, “medium-” and “high-glycemic” mean, interchangeably, “low-”, “medium-” and “high-insulinemic”.

Foods with a high-glycemic index increase blood glucose levels at higher level than foods with a low-glycemic index. Increased consumption of foods with a high-glycemic index lead to health conditions like diabetes. Consequently, decreasing the glycemic index of foods may decrease the development of health conditions like diabetes.

### Serving Size

The term “serving” or “serving size” refers to the amount of food normally consumed at one time by an average healthy individual. Food manufacturers usually indicate the serving size on a label describing the nutritional value of a food product, and under national food labeling laws, certain laws oblige you to provide specific instructions for determining the serving size of a food product. See, for example, US federal code under heading 21—Food and Drug Administration, § 101.12.

In some embodiments, a serving size is at least 1 calorie, at least 50 calories, at least 100 calories, at least 150 calories, at least 200 calories, at least 250 calories, at least 300 calories, at least 350 calories, at least 400 calories, at least 450 calories, at least 500 calories, at least 550 calories, at least 600 calories, at least 650 calories, at least 700 calories, at least 750 calories, at least 800 calories, at least 850 calories, at least 900 calories, at least 950 calories, or at least 1,000 calories.

In some embodiments, a serving size is about 1 calorie to 50 calories, about 50 calories to 100 calories, about 100 calories to 150 calories, about 150 calories to 200 calories, about 200 calories to 250 calories, about 250 calories to 300 calories, about 300 calories to 350 calories, about 350 calories to 400 calories, about 400 calories to 450 calories, about 450 calories to 500 calories, about 500 calories to 550 calories, about 550 calories to 600 calories, about 600 calories to 650 calories, about 650 calories to 700 calories, about 700 calories to 750 calories, about 750 calories to 800 calories, about 800 calories to 850 calories, about 850 calories to 900 calories, about 900 calories to 950 calories, or about 950 calories to 1,000 calories.

In some embodiments, a serving size is less than 1 gram of fat.

In some embodiments, a serving size is at least 1 gram of fat, at least 2 grams of fat, at least 3 grams of fat, at least 4 grams of fat, at least 5 grams of fat, at least 6 grams of fat, at least 7 grams of fat, at least 8 grams of fat, at least 9 grams of fat, at least 10 grams of fat, at least 11 grams of fat, at least 12 grams of fat, at least 13 grams of fat, at least 14 grams of fat, at least 15 grams of fat, at least 16 grams of fat, at least 17 grams of fat, at least 18 grams of fat, at least 19 grams of fat, or at least 20 grams of fat.

In some embodiments, a serving size is about 1 to 2 grams of fat, about 2 grams of fat to 3 grams of fat, about 3 grams of fat to 4 grams of fat, about 4 grams of fat to 5 grams of fat, about 5 grams of fat to 6 grams of fat, about 6 grams of fat to 7 grams of fat, about 7 grams of fat to 8 grams of fat, about 8 grams of fat to 9 grams of fat, about 9 grams of fat to 10 grams of fat, about 10 grams of fat to 11 grams of fat, about 11 grams of fat to 12 grams of fat, about 12 grams of fat to 13 grams of fat, about 13 grams of fat to 14 grams of fat, about 14 grams of fat to 15 grams of fat, about 15 grams of fat to 16 grams of fat, about 16 grams of fat to 17 grams of fat, about 17 grams of fat to 18 grams of fat, about 18 grams of fat to 19 grams of fat, or about 19 grams of fat to 20 grams of fat.

In some embodiments, a serving size is at least 1 gram of protein, at least 2 grams of protein, at least 3 grams of protein, at least 4 grams of protein, at least 5 grams of protein, at least 6 grams of protein, at least 7 grams of protein, at least 8 grams of protein, at least 9 grams of protein, at least 10 grams of protein, at least 11 grams of protein, at least 12 grams of protein, at least 13 grams of protein, at least 14 grams of protein, at least 15 grams of protein, at least 16 grams of protein, at least 17 grams of protein, at least 18 grams of protein, at least 19 grams of protein, at least 20 grams of protein, at least 25 grams of protein, at least 30 grams of protein, at least 35 grams of protein, at least 40 grams of protein, at least 45 grams of protein, or at least 50 grams of protein.

In some embodiments, a serving size is about 1 to about 2 grams of protein, about 2 grams of protein to about 3 grams of protein, about 3 grams of protein to about 4 grams of protein, about 4 grams of protein to about 5 grams of protein, about 5 grams of protein to about 6 grams of protein, about 6 grams of protein to about 7 grams of protein, about 7 grams of protein to about 8 grams of protein, about 8 grams of protein to about 9 grams of protein, about 9 grams of protein to about 10 grams of protein, about 10 grams of protein to about 11 grams of protein, about 11 grams of protein to about 12 grams of protein, about 12 grams of protein to about 13 grams of protein, about 13 grams of protein to about 14 grams of protein, about 14 grams of protein to about 15 grams of protein, about 15 grams of protein to about 16 grams of protein, about 16 grams of protein to about 17 grams of protein, about 17 grams of protein to about 18 grams of protein, about 18 grams of protein to about 19 grams of protein, about 19 grams of protein to about 20 grams of protein, about 20 grams of protein to about 25 grams of protein, about 25 grams of protein to about 30 grams of protein, about 30 grams of protein to about 35 grams of protein, about 35 grams of protein to about 40 grams of protein, about 40 grams of protein to about 45 grams of protein, or about 45 grams of protein to about 50 grams of protein.

In some embodiments, a serving size is less than 1 gram of carbohydrate.

In some embodiments, a serving size is at least 1 gram of carbohydrate, at least 2 grams of carbohydrate, at least 3 grams of carbohydrate, at least 4 grams of carbohydrate, at least 5 grams of carbohydrate, at least 6 grams of carbohydrate, at least 7 grams of carbohydrate, at least 8 grams of carbohydrate, at least 9 grams of carbohydrate, at least 10 grams of carbohydrate, at least 11 grams of carbohydrate, at least 12 grams of carbohydrate, at least 13 grams of carbohydrate, at least 14 grams of carbohydrate, at least 15 grams of carbohydrate, at least 16 grams of carbohydrate, at least 17 grams of carbohydrate, at least 18 grams of carbohydrate, at least 19 grams of carbohydrate, or at least 20 grams of carbohydrate.

In some embodiments, a serving size is about 1 to 2 grams of carbohydrate, about 2 grams of carbohydrate to 3 grams of carbohydrate, about 3 grams of carbohydrate to 4 grams of carbohydrate, about 4 grams of carbohydrate to 5 grams of carbohydrate, about 5 grams of carbohydrate to 6 grams of carbohydrate, about 6 grams of carbohydrate to 7 grams of carbohydrate, about 7 grams of carbohydrate to 8 grams of carbohydrate, about 8 grams of carbohydrate to 9 grams of carbohydrate, about 9 grams of carbohydrate to 10 grams of carbohydrate, about 10 grams of carbohydrate to 11 grams of carbohydrate, about 11 grams of carbohydrate to 12 grams of carbohydrate, about 12 grams of carbohydrate to 13 grams of carbohydrate, about 13 grams of carbohydrate to 14 grams of carbohydrate, about 14 grams of carbohydrate to 15 grams of carbohydrate, about 15 grams of carbohydrate to 16 grams of carbohydrate, about 16 grams of carbohydrate to 17 grams of carbohydrate, about 17 grams of carbohydrate to 18 grams of carbohydrate, about 18 grams of carbohydrate to 19 grams of carbohydrate, or about 19 grams of carbohydrate to 20 grams of carbohydrate.

### Shelf-Life

In some embodiments, the shelf-life of the food compositions of the disclosure have an increased shelf-life.

In some embodiments, the shelf-life is increased by at least 1 day, at least 2 days, at least 3 days, at least 4 days, at least 5 days, at least 6 days, at least 1 week, at least 2 weeks, at least 3 weeks, at least 4 weeks, at least 1 month, at least 2 months, at least 3 months, at least 4 months, at least, 5 months, at least 6 months, or at least 1 year.

In some embodiments, the shelf-life is increased about 1 day to 2 days, about 2 days to 3 days, about 3 days to 4 days, about 4 days to 5 days, about 5 days to 6 days, about 6 days to 7 days, about 1 week to 2 weeks, about 2 weeks to 3 weeks, about 3 weeks to 4 weeks, about 1 month to 2 months, about 2 months to 3 months, about 3 months to 4 months, about 4 months to 5 months, about 5 months to 6 months, or about 6 months to 1 year.

### EXAMPLES

The present disclosure is further illustrated by reference to the following Examples. However, it should be noted that these Examples, like the embodiments described above, are illustrative and are not to be construed as restricting the scope of the invention in any way.

### Example 1: Production of a High-Quality Protein Carrier

### Background

The carriers of the current disclosure solve a long-held need to provide high-quality protein in an easily consumable food-product, such as a sandwich.

High protein, low-fat diets can provide many health benefits including weight loss, muscle gain, and increased satiety (Johnson et al., The Journal of Nutrition, March 2004). Protein in food can be delivered in a variety of ways, including steaks, sandwiches, soups, etc. Generic carrier:filler food compositions are commonly designed with one or two carriers, such as a slice of bread, and typically include a filler that may be sweet or savory. Sweet or savory fillers include, but are not limited to, fruit fillers, meat fillers, meatless fillers, vegetables fillers, vegetable patty fillers, and/or cutlet fillers. Additional examples of generic carrier:filler food compositions are packaged foods. Packaged foods also include a carrier and a sweet or savory filler. Fillers for packaged foods include, but are not limited to, such as fruit fillers, meat fillers, meatless fillers, cheese fillers, vegan fillers, and/or vegetable fillers. Examples of packaged foods include, but are not limited to, “Pop Tarts”, “Uncrustables”, “Bagel Bites” and “Tortino's Pizza Roll”. These options only deliver less than 20% of calories coming from protein and most of the protein is in filler rather than in carrier.

While several attempts have been proposed to better fortify food with high-quality protein, all fall short of providing high-quality protein in the carrier to augment nutrition intake. For example, US20040208962A1 discloses a high protein peanut butter and jelly sandwich. This requires two slices of crustless baked bread, with protein in the filler. In contrast, the carrier of the present disclosure provides high-quality protein in the bread, irrespective of the filler. CA2522212A1 discloses high protein bakery products of only 12 to 16% by weight, with reduced moisture for freezing. Additionally, the protein from CA2522212A1 originates from cereal grains and not from a microbial protein, as disclosed herein. Furthermore, the percentage of protein (12 to 16%) is not complete protein. In the present disclosure, the carrier provides complete protein at quantities above 17%. RU2702089C1 provides a concept of a more nutritious bread; however, the nutrition comes from grain flours and beans and not from microbial sources. Furthermore, the application is silent on details regarding the nutritional qualities, such as PDCAAS etc.

Current Sandwiches and their Nutritional Properties

In some embodiments, a 4-ounce Impossible Sandwich filler comprises: 0 mg cholesterol, 19 g of protein, 14 g of total fat, 8 g of saturated fat and 240 calories. The Impossible Sandwich filler with a carrier of the current disclosure comprises: 0 mg cholesterol, 40 g of protein, 16 g of total fat, 8 g of saturated fat and 350 calories. In contrast, a similar burger with a generic carrier, such as a wheat bun, comprises: 0 mg cholesterol, 25 g of protein, 16 g of total fat, 8 g of saturated fat and 360 calories.

In some embodiments, a veggie burger on a bun would comprise: 365 Calories, 17 g fat, 36 g carbohydrate, and 18 g protein. By contrast, the present disclosure provides significantly more protein and reduced carbohydrates: 340 calories, 17 g fat, 15 g carbohydrates and 32 g protein.

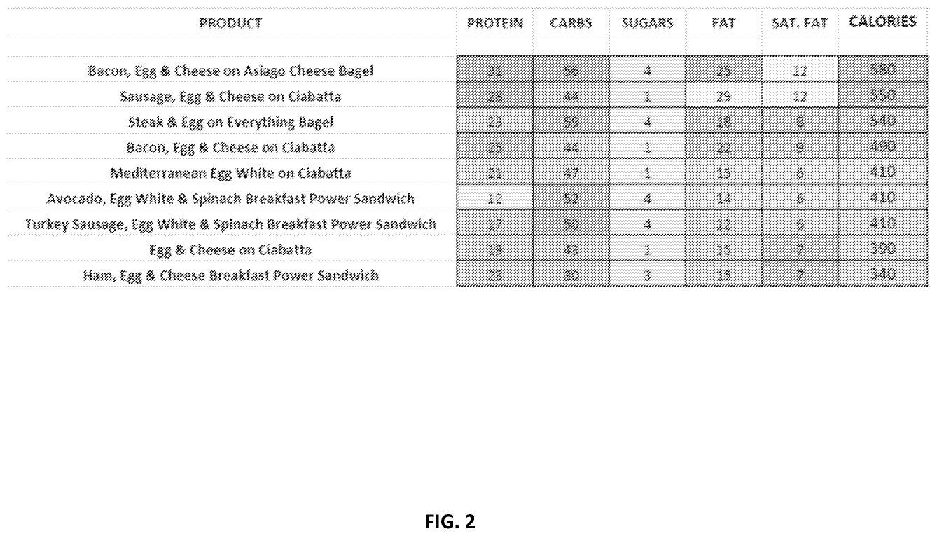

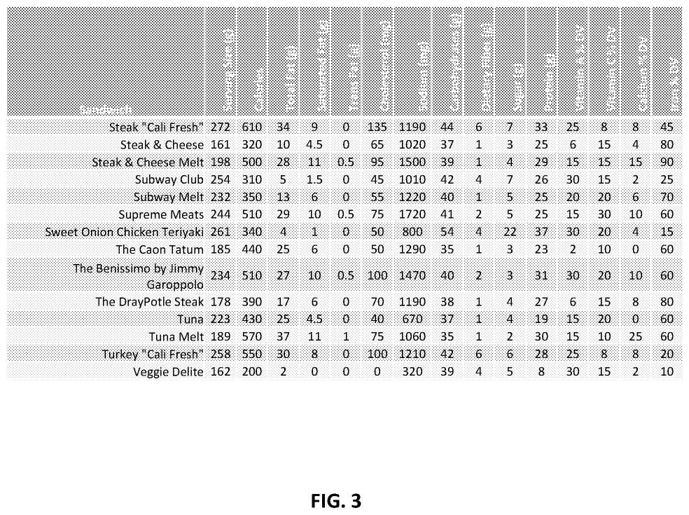

Additional exemplary sandwiches from Panera Bread and Subway and their nutritional characteristics, including the Subway Veggie Delite, are shown in FIG. 2 and FIG. 3, respectively.

### Purpose

This goal of this Example was to provide a high-quality, high protein carrier for use in in a high-protein food composition, such as a sandwich, where most of the protein is present in the carrier, such as a bun or bread as shown in FIG. 1. This increased protein allows for greater delivery of calories via protein, while reducing calories delivered by carbohydrates or fat, which increases nutritional quality.

### Materials and Methods

A high-protein, microbially derived protein powder was sourced from precision fermentation using either eukaryotes, prokaryotes, or a mixture of both. Methods to determine high-quality microbially derived protein are disclosed in US2023281444A1, which is incorporated by reference in its entirety. Microbially derived protein is superior to other protein sources because microbially derived protein provides higher nutritional quality. Additionally, utilizing the methods disclosed in US2023281444A1 would allow for customization of precise nutritional quality parameters including, but not limited to, PDCAAS and/or specific percentages of NEAAs and EAAs in carriers of the present disclosure. Alternatively, high-protein, microbially derived protein powder may be produced from fermented biomass using methods described in co-pending US provisional patent application U.S. 63/428,014, filed Nov. 25, 2022, which is incorporated by reference in its entirety for all purposes.

The high-protein, microbially derived protein powder was mixed with flour and water to prepare a dough using methods to maximize proper hydration of the protein and flour in the dough. The dough was then shaped and baked into a typical carrier form, such as a bun form or loaf.

Cella carrier (“Classic Wheat Bread”) was prepared as follows: water (43.0 wt %) at 10° C. was mixed with vinegar (2 wt %). To this liquid was added a comestible comprising flour (29.78 wt %), a microbial protein/plant protein blend (i.e., Cella protein; 23.25 wt %), and leavening (active dry yeast (1 wt %)). The Cella protein comprised a water hydration capacity (WHC) of 82-88% by weight and the microbial protein was obtained by fermentation of plant biomass (e.g., wheat durum flour) by a microbe (i.e., S. cerevisiae). An exemplary type of protein blend that fits these parameters and could be used includes Equii™ Bread Protein Blend available from Equii (Equii Suite 123, 1930 Innovation Way, Libertyville, IL 60048)). These ingredients were mixed at low speed for 5 minutes, then for 5 minutes at high speed. Non-GMO canola oil (1.0 wt %) was added and mixing at low speed was carried out for 1 minute to form a homogenous composition comprising a cohesive dough. The dough was rounded by hand in loaf-sized portions and allowed to rest for 20 minutes, shaped by hand into loaf shapes, placed into bread pan and smoothed to ensure even distribution of the dough. The top was brushed lightly with water and sprinkled with a topping of wheat bran. Loaves were proofed at 92° F. to 94° F. for 90 minutes, then baked at 340° F. to 345° F. for 42 minutes.

Cella carrier buns were prepared the same way except the dough was formed into buns before baking.

### Results and Conclusions

The PDCAAS value of the above dough and subsequent baked bread was 0.92 as shown in Example 8. By altering the ratio of the Cella protein (e.g., Equii™ Bread Protein Blend) and flour, PDCAAS values of 0.7 to 0.95 can be achieved in various high protein baked goods including breads or buns. Foods with PDCAAS value 0.8 and above are considered foods with complete protein. In contrast, wheat flour lacks essential amino acids, including lysine, and has a PDCAAS value of 0.42, and is not considered a complete protein (Schaafsma, G. (July 2000). “The protein digestibility-corrected amino acid score”. The Journal of Nutrition. 130 (7): 1865S-7S. doi:10.1093/jn/130.7.1865S. PMID 10867064.)

As outlined in the following Examples, once the high protein carrier bread or bun is baked, a filler can be selected and added with the carrier. The sandwich can then be packaged in either a suitable packaging for fresh format delivery or frozen format delivery or the sandwich can be served fresh.

### Examples 2-7: Sandwich Examples Using the High Protein Carrier of the Current Disclosure

A variety of sandwiches are constructed showing the nutritional properties obtained when using various fillers with the high-protein bread/carrier delivered in this application, such as, for example, the high-protein bread/carrier produced in Example 1. This allows for high nutritional properties, in particular high amounts of protein, to be delivered with a variety of fillings. The results of these examples solve a longstanding need by providing a carrier with high-quality protein that can be used in several different types of food compositions.

The tables of these examples show the protein, total carbohydrates, sugar, fat, and calories for exemplary food compositions that utilize high-protein bread/carriers described throughout the present disclosure (e.g., the high-protein bread/carrier produced in Example 1) and compared to a generic carrier. In some embodiments, the protein content of exemplary carrier:filler compositions comprising the carrier of the present disclosure (e.g., the high-protein bread/carrier produce in Example 1) is greater than the protein content of a carrier:filler food composition made from a generic carrier. In some embodiments, the carbohydrate content of exemplary carrier:filler compositions comprising the carrier of the present disclosure (e.g., the high-protein bread/carrier produce in Example 1) is lower than the carbohydrate content of carrier:filler food composition made from a generic carrier. In some embodiments, the total calorie content of exemplary carrier:filler compositions comprising the carrier of the present disclosure (e.g., the high-protein bread/carrier produce in Example 1) is lower than the total calorie content of carrier:filler food composition made from a generic carrier.

### Example 2: Comparison of Sandwich Food Products Prepared with Different Carriers and Comprising a Plant-Based Filler-Lettuce and Tomato Sandwich

### Objective:

The purpose of this Example is to determine the ratio of protein provided by the carrier (i.e., sandwich bread) to protein provided by plant-based filler (i.e., lettuce and tomato) in vegetable sandwiches prepared with either a commercially available carrier/sandwich bread or a high protein bread/carrier as provided herein (e.g., the high protein bread/carrier prepared in Example 1). Two sandwiches, both single serving, comprising a carrier, tomato, and lettuce are prepared. The first sandwich is prepared using a commercially available carrier (i.e., comparative sandwich), while the second sandwich is prepared using a high protein bread/carrier (“Cella Carrier”) made with the Cella protein as provided herein (i.e., the high protein bread/carrier prepared in Example 1).

Production of a Vegetable (Commercially Available Carrier Sandwich Bread) with Lettuce and Tomato Sandwich

TABLE 3
Sandwich prepared with commercially available carrier
(sandwich bread), tomato and lettuce-single serving.

| | Commercially available | |
|---|---|---|
| | Carrier (Sandwich bread) | Complete sandwich |
| | Dave's Killer Bread ™ | (carrier with |
| | White Bread Done Right | tomato and lettuce) |
| Protein (grams) | 6 | 7 |
| Calories from protein | 24 | 28 (12.1%) |
| Carbohydrates (grams) | 42 | 45 |
| Fiber (grams) | 4 | 5 |
| Sugar (grams) | 4 | 4 |
| Fat (grams) | 4 | 4 |
| Calories | 220 | 230 |

The ratio of protein from the carrier (6 grams) to the protein of the filler (1 gram (=7 grams−6 grams)) (the carrier:filler protein ratio) of the resulting vegetable sandwich comprising lettuce and tomato from Table 3 is 6:1 (6 grams of protein from the carrier: 1 gram of protein from the filling), or 6:1. The calories per serving originating from protein of this comparative sandwich prepared with commercially available carrier (sandwich bread) are less than 20% of total calories from protein per serving: 28 calories, or 12.1% of total calories from protein per serving. The total calories of the food composition are 230 calories.

Production of a Vegetable on High Protein Bread/Carrier (“Cella Carrier”) with Lettuce and Tomato Sandwich.

The second sandwich is a single serving prepared as described for the comparative sandwich, except the carrier is a high protein bread/carrier (“Cella Carrier”).

TABLE 4
Sandwich prepared using high protein bread/carrier-single serving.

| | High protein | Complete high | |
|---|---|---|---|
| | bread/carrier | protein bread/ | |
| | (“Cella Carrier | carrier (“Cella | |
| | from Example 1”) | Carrier”) sandwich | |
| Protein (grams) | 15 | 16 | |
| Microbial protein | 9 g (60%) | 9 g | (56%) |
| Calories from protein | 60 | 64 | (32%) |

| | | |
|---|---|---|
| Carbohydrates (grams) | 25 | 27 |
| Fiber (grams) | 2 | 2 |
| Sugar (grams) | 3 | 3 |
| Fat (grams) | 5 | 5 |
| Calories | 180 | 200 |

The ratio of protein from the carrier (15 grams) to the protein of the filler (1 grams (=16 grams−15 grams)) (the carrier:filler protein ratio) of the resulting high protein bread/carrier (“Cella Carrier”) bread with lettuce and tomato sandwich is 15:1 (15 grams of protein from the carrier: 1 grams of protein from the filling=15). As shown in Table 4, the calories per serving originating from protein of this sandwich prepared with Cella carrier are greater than 20% of total calories from protein per serving: 64 calories, or 32% of total calories from protein per serving. The total calories of the food composition are 200 calories, which is less than 640 total calories per serving.

### Example 3: Comparison of Sandwich Food Products Prepared with Different Carriers and Comprising Meat-Based and Plant-Based Fillers-Turkey Breast Sandwich

### Objective:

The purpose of this Example is to determine the ratio of protein provided by the carrier (i.e., sandwich bread) to protein provided by a meat-based filler (i.e., turkey breast) in sandwiches prepared with either a commercially available carrier/sandwich bread or a high protein bread/carrier as provided herein (e.g., the high protein bread/carrier prepared in Example 1). Two sandwiches, both single serving, comprising a carrier, turkey breast, lettuce and tomato are prepared. The first sandwich is prepared using a commercially available carrier (i.e., comparative sandwich), while the second sandwich is prepared using a high protein bread/carrier (“Cella Carrier”) made with the Cella protein as provided herein (i.e., the high protein bread/carrier prepared in Example 1).

Production of a Turkey Breast on White Bread with Lettuce and Tomato Sandwich

The comparative sandwich is a single serving prepared using a commercially available white bread as well as turkey breast, lettuce and tomato

TABLE 5
Comparative sandwich prepared with commercially available
white bread, turkey and lettuce and tomato-single serving.

| | Commercially available | |
|---|---|---|
| | Carrier (Sandwich bread) | |
| | Dave's Killer Bread ™ | Complete |
| | White Bread Done Right | sandwich |
| Protein (grams) | 6 | 16 |
| Calories from protein | 24 | 64 (22.8%) |
| Carbohydrates (grams) | 42 | 47 |
| Fiber (grams) | 4 | 5 |
| Sugar (grams) | 4 | 5 |
| Fat (grams) | 4 | 5 |
| Calories | 220 | 280 |

The ratio of protein from the carrier (6 grams) to the protein of the filler(10 grams (=16 grams−6 grams)) (the carrier:filler protein ratio) of the resulting turkey breast sandwich is 6:10, or 0.6:1. As shown in Table 5, the calories per serving originating from protein of this comparative sandwich prepared with commercially available white bread are less than 20% of total calories from protein per serving: 64 calories, or 22.8% of total calories from protein per serving. The total calories of the food composition are 280 calories.

Production of a Turkey Breast on High Protein Bread/Carrier (“Cella Carrier”) with Lettuce and Tomato Sandwich.

The second sandwich is a single serving that was prepared just as the comparative sandwich in this Example, except the carrier is high protein bread/carrier (“Cella Carrier”) such as those provided herein (e.g., high protein bread/carrier from Example 1).

TABLE 6
Sandwich prepared using high protein bread/carrier-single serving.

| | High protein | Complete high | |
|---|---|---|---|
| | bread/carrier | protein bread/ | |
| | (“Cella Carrier | carrier (“Cella | |
| | from Example 1”) | Carrier”) sandwich | |
| Protein (grams) | 15 | 25 | |
| Microbial protein | 9 g (60%) | 9 g | (36%) |
| Calories from protein | 60 | 100 | (40%) |

| | | |
|---|---|---|
| Carbohydrates (grams) | 25 | 29 |
| Fiber (grams) | 2 | 2 |
| Sugar (grams) | 3 | 4 |
| Fat (grams) | 5 | 6 |
| Calories | 180 | 250 |

The ratio of protein from the carrier (15 grams) to the protein of the filler (10 grams (=25 grams−15 grams)) (the carrier:filler protein ratio) of the resulting turkey breast sandwich is 15:10, or 1.5:1. As shown in Table 6, the calories per serving originating from protein of this sandwich prepared with Cella carrier are greater than 20% of total calories from protein per serving: 100 calories, or 40% of total calories from protein per serving. The total calories of the food composition are 250 calories, which is less than 640 total calories per serving.

### Example 4: Comparison of Sandwich Food Products Prepared with Different Carriers and Comprising Meat-Based and Plant-Based Fillers-Steak and Cheese Sandwich

### Objective:

The purpose of this Example is to determine the ratio of protein provided by the carrier (i.e., sandwich bread) to protein provided by a meat-based filler (i.e., steak and cheese) in sandwiches prepared with either a commercially available carrier/sandwich bread or a high protein bread/carrier as provided herein (e.g., the high protein bread/carrier prepared in Example 1). Two sandwiches, both single serving, comprising a carrier, steak, cheese, lettuce and tomato are prepared. The first sandwich is prepared using a commercially available carrier (i.e., comparative sandwich), while the second sandwich is prepared using a high protein bread/carrier (“Cella Carrier”) made with the Cella protein as provided herein (i.e., the high protein bread/carrier prepared in Example 1).

Production of a Steak and Cheese on White Bread with Lettuce, Tomato Sandwich

The first, comparative sandwich is a single serving prepared using a commercially available white bread as well as steak, cheese, lettuce and tomato.

TABLE 7
Comparative sandwich prepared with commercially available white
bread, steak, cheese and lettuce and tomato-single serving.

| | Commercially available | |
|---|---|---|
| | Carrier (Sandwich bread) | |
| | Dave's Killer Bread ™ | Complete |
| | White Bread Done Right | sandwich |
| Protein (grams) | 6 | 20 |
| Calories from protein | 24 | 80 (21%) |
| Carbohydrates (grams) | 42 | 46 |
| Fiber (grams) | 4 | 5 |
| Sugar (grams) | 4 | 4 |
| Fat (grams) | 4 | 15 |
| Calories | 220 | 380 |

The ratio of protein from the carrier (6 grams) to the protein of the filler (14 grams (=20 grams−6 grams)) (the carrier:filler protein ratio) of the resulting steak and cheese sandwich is 6:14, or 0.43:1. As shown in Table 7, the calories per serving originating from protein of this comparative sandwich prepared with commercially available white bread are less than 20% of total calories from protein per serving: 80 calories, or 21% of total calories from protein per serving. The total calories of the food composition are 380 calories.

Production of a Steak and Cheese on High Protein Bread/Carrier (“Cella Carrier”) with Lettuce, Tomato Sandwich

The second sandwich is a single serving that was prepared just as the comparative sandwich in this Example, except the carrier is high protein bread/carrier (“Cella Carrier”) such as those provided herein (e.g., high protein bread/carrier from Example 1).

TABLE 8
Sandwich prepared using high protein bread/carrier-single serving.

| | High protein | Complete high | |
|---|---|---|---|
| | bread/carrier | protein bread/ | |
| | (“Cella Carrier | carrier (“Cella | |
| | from Example 1”) | Carrier”) sandwich | |
| Protein (grams) | 15 | 29 | |
| Microbial protein | 9 g (60%) | 9 g | (31%) |
| Calories from protein | 60 | 116 | (33%) |

| | | |
|---|---|---|
| Carbohydrates (grams) | 25 | 28 |
| Fiber (grams) | 2 | 2 |
| Sugar (grams) | 3 | 3 |
| Fat (grams) | 5 | 16 |
| Calories | 180 | 350 |

The ratio of protein from the carrier (15 grams) to the protein of the filler (14 grams (=29 grams−15 grams)) (the carrier:filler protein ratio) of the resulting steak and cheese sandwich is 15:14, or 1.07:1. As shown in Table 8, the calories per serving originating from protein of this sandwich prepared with Cella carrier are greater than 20% of total calories from protein per serving: 116 calories, or 33% of total calories from protein per serving. The total calories of the food composition are 350 calories, which is less than 640 total calories per serving.

### Example 5: Comparison of Sandwich Food Products Prepared with Different Carriers and Comprising Peanut Butter and Jelly Fillers

### Objective:

The purpose of this Example is to determine the ratio of protein provided by the carrier (i.e., sandwich bread) to protein provided by a peanut butter and jelly filler in sandwiches prepared with either a commercially available carrier/sandwich bread or a high protein bread/carrier as provided herein (e.g., the high protein bread/carrier prepared in Example 1). Two sandwiches, both single serving, comprising a carrier, peanut butter and jelly are prepared. The first sandwich is prepared using a commercially available white-bread/carrier (i.e., comparative sandwich), while the second sandwich is prepared using a high protein bread/carrier (“Cella Carrier”) made with the Cella protein as provided herein (e.g., the high protein bread/carrier prepared in Example 1).

### Production of a Peanut Butter and Jelly Sandwich on White Bread

The first, comparative sandwich is a single serving prepared using a commercially available white bread as well as peanut butter and jelly.

TABLE 9
Comparative sandwich prepared with commercially available
white bread, peanut butter and jelly-single serving.

| | Commercially available | |
|---|---|---|
| | Carrier (Sandwich bread) | |
| | Dave's Killer Bread ™ | Complete |
| | White Bread Done Right | sandwich |
| Protein (grams) | 6 | 13 |
| Calories from protein | 24 | 52 (11.3%) |
| Carbohydrates (grams) | 42 | 61 |
| Fiber (grams) | 4 | 6 |
| Sugar (grams) | 4 | 19 |
| Fat (grams) | 4 | 20 |
| Calories | 220 | 460 |

The ratio of protein from the carrier (6 grams) to the protein of the filler (7 grams (=13 grams−6 grams)) (the carrier:filler protein ratio) of the resulting peanut butter and jelly sandwich is 6:7, or 0.86:1. As shown in Table 9, the calories per serving originating from protein of this comparative sandwich prepared with commercially available white bread are less than 20% of total calories from protein per serving: 52 calories, or 11.3% of total calories from protein per serving. The total calories of the food composition are 460 calories.

### Production of a Peanut Butter and Jelly on High Protein Bread/Carrier (“Cella Carrier”)

The second sandwich is a single serving that was prepared just as the comparative sandwich in this Example, except the carrier is high protein bread/carrier (“Cella Carrier”) such as those provided herein (e.g., high protein bread/carrier from Example 1).

TABLE 10
Sandwich prepared using high protein bread/carrier-single serving.

| | High protein bread/carrier | Complete high protein | |
|---|---|---|---|
| | (“Cella Carrier | bread/carrier (“Cella | |
| | from Example 1”) | Carrier”) sandwich | |
| Protein (grams) | 15 | 22 | |
| Microbial protein | 9 g (60%) | 9 g | (41%) |
| Calories from protein | 60 | 88 | (20.9%) |

| | | |
|---|---|---|
| Carbohydrates (grams) | 25 | 44 |
| Fiber (grams) | 2 | 4 |
| Sugar (grams) | 3 | 18 |
| Fat (grams) | 5 | 21 |
| Calories | 180 | 420 |

The ratio of protein from the carrier (15 grams) to the protein of the filler (7 gram (=22 grams−15 grams)) (the carrier:filler protein ratio) of the resulting peanut butter and jelly sandwich is 15:7 or 2.14:1. As shown in Table 10, the calories per serving originating from protein of this sandwich prepared with Cella carrier are greater than 20% of total calories from protein per serving: 88 calories, or 20.9% of total calories from protein per serving. The total calories of the food composition are 420 calories, which is less than 640 total calories per serving.

### Example 6: Comparison of Meat-Based Cheeseburger Food Products Prepared with Different Carriers

### Objective:

The purpose of this Example is to determine the ratio of protein provided by the carrier (i.e., hamburger bun) to protein provided by a meat patty and slice of cheese in cheeseburgers prepared with either a commercially available carrier/bun or a high protein bread/carrier as provided herein (e.g., a high protein bread/carrier such as described in Example 1). Two cheeseburgers, both single serving, comprising a carrier, a meat patty and a slice of cheese are prepared. The first cheeseburger is prepared using a commercially available bun/carrier (i.e., comparative cheeseburger), while the second cheeseburger is prepared using a high protein bread/carrier (“Cella Carrier”) made with Cella protein as provided herein.

Production of a Cheeseburger with a Commercially Available Bun

The first burger is a single serving prepared using a commercially available bun.

TABLE 11
Comparative cheeseburger prepared with commercially available
bun, single serving.

| | Commercially available | Complete |
|---|---|---|
| | McDonald's ™ Bun | cheeseburger |
| Protein (grams) | 5 | 15 |
| Calories from protein | 20 | 60 (20.6%) |
| Carbohydrates (grams) | 28 | 44 |
| Fiber (grams) | 1 | 1 |
| Sugar (grams) | 5 | 8 |
| Fat (grams) | 2 | 10 |
| Calories | 150 | 290 |

The ratio of protein from the carrier (5 grams) to the protein of the filler (10 grams (=15 grams−5 grams)) (the carrier:filler protein ratio) of the resulting cheeseburger is 5:10, or 0.5:1. As shown in Table 11, the calories per serving originating from protein of this comparative burger prepared with a commercially available bun are less than 20% of total calories from protein per serving: 60 calories, or 20.6% of total calories from protein per serving. The total calories of the food composition are 290 calories.

### Production of a Cheeseburger on High Protein Bread/Carrier (“Cella Carrier”)

The second burger is a single serving prepared as for the comparative cheeseburger in this Example, except the carrier is high protein bread/carrier (“Cella Carrier”) such as those provided herein (e.g., high protein bread/carrier from Example 1).

TABLE 12
Cheeseburger prepared using high protein bread/carrier-single
serving.

| | High protein | Complete high | |
|---|---|---|---|
| | bread/carrier | protein bread/carrier | |
| | (“Cella Carrier from | (“Cella Carrier”) | |
| | Example 1”) bun | cheeseburger | |
| Protein (grams) | 10 | 20 | |
| Microbial protein | 5 g (50%) | 5 g | (25%) |
| Calories from protein | 40 | 80 | (28.5%) |

| | | |
|---|---|---|
| Carbohydrates (grams) | 14 | 18 |
| Fiber (grams) | 1 | 1 |
| Sugar (grams) | 2 | 5 |
| Fat (grams) | 3 | 11 |
| Calories | 140 | 280 |

The ratio of protein from the carrier (10 grams) to the protein of the filler (10 gram (=20 grams−10 grams)) (the carrier:filler protein ratio) of the resulting cheeseburger is 10:10 or 1:1. As shown in Table 12, the calories per serving originating from protein of this cheeseburger prepared with Cella carrier are greater than 20% of total calories from protein per serving: 80 calories, or 28.5% of total calories from protein per serving. The total calories of the food composition are 280 calories, which is less than 640 total calories per serving.

### Example 7: Comparison of Plant-Based Cheeseburger Food Products Prepared with Different Carriers

### Objective:

The purpose of this Example is to determine the ratio of protein provided by the carrier (i.e., hamburger bun) to protein provided by a plant-based patty made of beans and slice of cheese in cheeseburgers prepared with either a commercially available carrier/bun or a high protein bread/carrier as provided herein (e.g., a high protein bread/carrier such as described in Example 1). Two cheeseburgers, both single serving, comprising a carrier, a plant based, bean patty and a slice of cheese are prepared. The first cheeseburger is prepared using a commercially available bun/carrier (i.e., comparative cheeseburger), while the second cheeseburger is prepared using a high protein bread/carrier (“Cella Carrier”) made with Cella protein as provided herein.

Production of a Plant-Based Burger with a Commercially Available Bun

The first burger is a single serving prepared using a commercially available bun as a comparative example.

TABLE 13
Comparative burger prepared with commercially available bun,
plant-based bean patty and a slice of cheese-ingle serving.

| | Commercially available | Complete |
|---|---|---|
| | McDonald's ™ Bun | cheeseburger |
| Protein (grams) | 5 | 15 |
| Calories from protein | 20 | 60 (11.1%) |
| Carbohydrates (grams) | 28 | 57 |
| Fiber (grams) | 1 | 5 |
| Sugar (grams) | 5 | 11 |
| Fat (grams) | 2 | 15 |
| Calories | 150 | 440 |

The ratio of protein from the carrier (5 grams) to the protein of the filler (10 grams (=15 grams−5 grams)) (the carrier:filler protein ratio) of the resulting plant-based burger is 5:10, or 0.5:1. As shown in Table 13, the calories per serving originating from protein of this comparative burger prepared with commercially available bun are less than 20% of total calories from protein per serving: 60 calories, or 11.1% of total calories from protein per serving. The total calories of the food composition are 440 calories.

### Production of a Plant-Based Burger Prepared on High Protein Bread/Carrier (“Cella Carrier”)

The second burger is a single serving prepared as for the comparative cheeseburger, except the carrier is high protein bread/carrier (“Cella Carrier”).

TABLE 14
Burger prepare using high protein bread bun/carrier-single
serving.

| | High protein | | | |
|---|---|---|---|---|
| | bread/carrier | | Complete high | |
| | (“Cella | | protein | |
| | Carrier from | | bread/carrier | |
| | Example 1”) | | (“Cella Carrier”) | |
| | bun | | cheeseburger | |
| Protein (grams) | 16 | | 26 | |
| Microbial protein | 9 g | (56%) | 9 g | (34%) |

| | | | |
|---|---|---|---|
| Calories from protein | 64 | 104 | (20.5%) |

| | | |
|---|---|---|
| Carbohydrates (grams) | 23 | 52 |
| Fiber (grams) | 1 | 5 |
| Sugar (grams) | 3 | 9 |
| Fat (grams) | 4 | 17 |
| Calories | 220 | 510 |

The ratio of protein from the carrier (16 grams) to the protein of the filler (10 grams (=26 grams−16 grams)) (the carrier:filler protein ratio) of the resulting plant-based burger is 16:10, or 1.6:1. As shown in Table 14, the calories per serving originating from protein of this cheeseburger prepared with Cella carrier are greater than 20% of total calories from protein per serving: 104 calories, or 20.5% of total calories from protein per serving. The total calories of the food composition are 510 calories, which is less than 640 total calories per serving.

### Example 8. Comparison of High Protein Carriers of Present Disclosure to Known Amino Acid Requirements

The amino acid composition of two different Cella/EQUII high protein carriers was measured and compared to the levels of amino acid requirements (FAO Food and Nutrition Paper 51, “Protein Quality Evaluation”, Report of the Joint FAO/WHO Expert Consultation, Bethesda, MD, USA, 4-8 Nov. 1989, available at www.fao.org/3/t0501e/t0501e.pdf) in the tables below.

TABLE 15
Amino acid composition in Cella/EQUII high protein carrier
(10 g protein per serving). The FAO column listed the requirement
for children ages 2-5.

| | | | Amino Acid Ratio |
|---|---|---|---|
| | FAO | Cella/EQUII high | (comparison between |
| | (mg/g | protein bread | FAO requirement and |
| EAA/IAA | protein) | (mg/g protein) | CELLA Bread) |
| Histidine | 19 | 24 | 1.3 |
| Isoleucine | 28 | 46 | 1.6 |
| Lysine | 66 | 72 | 1.09 |
| Leucine | 58 | 79 | 1.4 |
| Methionine + | 25 | 29 | 1.2 |
| cystine | | | |
| Phenylalanine + | 63 | 80 | 1.0 |
| tyrosine | | | |
| Threonine | 34 | 40 | 1.2 |
| Tryptophan | 11 | 13 | 1.2 |
| Valine | 35 | 56 | 1.6 |
| PDCAAS in | | 0.92 | |
| baked bread | | | |

TABLE 16
Amino acid composition in Cella/EQUII high protein carrier
(8 g protein per serving)

| | | Cella/EQUII | Amino Acid Ratio |
|---|---|---|---|
| | FAO | high protein | (comparison between |
| | (mg/g | bread (mg/g | FAO requirement and |
| EAA/IAA | protein) | protein) | CELLA Bread) |
| Histidine | 19 | 23 | 1.2 |
| Isoleucine | 28 | 43 | 1.5 |
| Lysine | 66 | 59 | 0.89 |
| Leucine | 58 | 76 | 1.3 |
| Methionine + cystine | 25 | 32 | 1.3 |
| Phenylalanine + | 63 | 79 | 1.0 |
| tyrosine | | | |
| Threonine | 34 | 36 | 1.1 |
| Tryptophan | 11 | 12 | 1.1 |
| Valine | 35 | 52 | 1.5 |
| PDCAAS in baked | | 0.82 | |
| bread | | | |

### Example 9. Bread Recipes Utilizing Varying Percentages of Microbially Produced and Non-Microbially Produced (e.g., Plant-Based) Protein

The purpose of this Example is to provide alternative recipes for producing high-quality, high-protein breads using varying percentages of microbially produced protein and/or plant-produced protein.

The ingredients in each of Tables 17-24 are mixed at low speed for 5 minutes, then for 5 minutes at high speed. Non-GMO canola oil (1.0 wt %) is added and mixing at low speed is carried out for 1 minute to form a homogenous composition comprising a cohesive dough. The dough is rounded by hand in loaf-sized portions and allowed to rest for 20 minutes, shaped by hand into loaf shapes, placed into bread pan and smoothed to ensure even distribution of the dough. The top is brushed lightly with water and sprinkled with a topping of wheat bran. Loaves are proofed at 92° F. to 94° F. for 90 minutes, then baked at 340° F. to 345° F. for 42 minutes.

TABLE 17
Bread Recipe 1-Mixture of plant-based and microbially
produced protein

| Ingredient | %, wt basis |
|---|---|
| High gluten wheat Flour | 33 |
| Cella Protein from Example 1 | 13.5 |
| Water | 47.5 |
| Fresh Yeast | 1 |
| Sugar or sweeteners (optional) | — |
| Salt | 1 |
| Other bakery ingredients to improve dough | 3.0 |
| Bakery Enzymes and Lecithin (optional) | 1 |
| Vegetable oil (optional) | — |
| Total | 100 |
| PDCAAS | 0.90 |
| Protein % | 20% |

TABLE 18
Bread Recipe 2-Mixture of plant-based and microbially
produced protein

| Ingredient | %, wt basis |
|---|---|
| High gluten wheat Flour | 35 |
| Cella Protein from Example 1 | 10.5 |
| Water | 47.5 |
| Fresh Yeast | 1.0 |
| Sugar or sweeteners (optional) | 1.0 |
| Salt | 1.0 |
| Other bakery ingredients to improve dough | 3.0 |
| Bakery Enzymes and Lecithin (optional) | 1.0 |
| Vegetable oil (optional) | — |
| Total | 100 |
| PDCAAS | 0.81 |
| Protein % | 20% |

TABLE 19
Bread Recipe 3-Mixture of multiple plant-based produced proteins

| Ingredient | %, wt basis |
|---|---|
| High gluten wheat Flour | 35 |
| Pea Protein (Nutralys ® S85F) | 10.5 |
| Water | 47.5 |
| Fresh Yeast | 1.0 |
| Sugar or sweeteners (optional) | 1.0 |
| Salt | 1.0 |
| Other bakery ingredients to improve dough | 3.0 |
| Bakery Enzymes and Lecithin (optional) | 1.0 |
| Vegetable oil (optional) | — |
| Total | 100 |
| PDCAAS | 0.60 |
| Protein % | 20% |

TABLE 20
Bread Recipe 4-Mixture of multiple plant-based produced proteins

| Ingredient | %, wt basis |
|---|---|
| High gluten wheat Flour | 35 |
| Chickpea protein | 13.5 |
| concentrate (Tate & Lyle) | |
| Artesa ™ Chickpea Protein, | |
| 100-P-1 | |
| Water | 44.5 |
| Fresh Yeast | 1.0 |
| Sugar or sweeteners | 1.0 |
| (optional) | |
| Salt | 1.0 |
| Other bakery ingredients to | 3.0 |
| improve dough | |
| Bakery Enzymes and | 1.0 |
| Lecithin (optional) | |
| Vegetable oil (optional) | — |
| Total | 100 |
| PDCAAS | 0.43 |
| Protein % | 20% |

TABLE 21
Bread Recipe 5-Mixture of multiple plant-based produced proteins

| Ingredient | %, wt basis |
|---|---|
| High gluten wheat Flour | 35 |
| Rice protein Oryzatein ™ 80 (Axiom | 10.5 |
| Foods (Los Angeles, CA)) | |
| Water | 47.5 |
| Fresh Yeast | 1.0 |
| Sugar or sweeteners (optional) | 1.0 |
| Salt | 1.0 |
| Other bakery ingredients to improve dough | 3.0 |
| Bakery Enzymes and Lecithin (optional) | 1.0 |
| Vegetable oil (optional) | — |
| Total | 100 |
| PDCAAS | 0.54 |
| Protein % | 20% |

TABLE 22
Bread Recipe 6-Mixture of multiple plant-based produced proteins

| Ingredient | %, wt basis |
|---|---|
| High gluten wheat Flour | 35 |
| Soy Protein Isolate | 10.5 |
| Water | 47.5 |
| Fresh Yeast | 1.0 |
| Sugar or sweeteners | 1.0 |
| (optional) | |
| Salt | 1.0 |
| Other bakery ingredients to | 3.0 |
| improve dough | |
| Bakery Enzymes and | 1.0 |
| Lecithin (optional) | |
| Vegetable oil (optional) | — |
| Total | 100 |
| PDCAAS | 0.65 |
| Protein % | 20% |

TABLE 23
Bread Recipe 7-Mixture of multiple plant-based produced proteins

| Ingredient | %, wt basis |
|---|---|
| High gluten wheat Flour | 35 |
| Cella Protein from Example 1 | 8 |
| Soy Protein Isolate | 6 |
| Water | 44 |
| Fresh Yeast | 1.0 |
| Sugar or sweeteners (optional) | 1.0 |
| Salt | 1.0 |
| Other bakery ingredients to improve | 3.0 |
| dough | |
| Bakery Enzymes and Lecithin | 1.0 |
| (optional) | |
| Vegetable oil (optional) | — |
| Total | 100 |
| PDCAAS | 0.81 |
| Protein % | 20% |

TABLE 24
Bread Recipe 8-Mixture of multiple plant-based produced proteins

| Ingredient | %, wt basis |
|---|---|
| High gluten wheat Flour | 35 |
| Cella Protein from Example 1 | 9 |
| Pea Protein (Nutralys ® | 5 |
| S85F | |
| Water | 44 |
| Fresh Yeast | 1.0 |
| Sugar or sweeteners | 1.0 |
| (optional) | |
| Salt | 1.0 |
| Other bakery ingredients to | 3.0 |
| improve dough | |
| Bakery Enzymes and | 1.0 |
| Lecithin (optional) | |
| Vegetable oil (optional) | — |
| Total | 100 |
| PDCAAS | 0.81 |
| Protein % | 20% |

### Results and Conclusions

As shown in Tables 17-24, breads produced comprising mixtures of plant-based protein sources should be able to achieve good PDCAAS values of at least 0.6 or higher. However, the addition of microbially produced proteins, allows for the production of breads that should be able to achieve PDCAAS values of at least 0.8. As such, mixtures of plant-based proteins can be used to generate carriers comprising solid PDCAAS values, but the use of microbially produced proteins either alone or in mixtures with other protein sources, such as plant-based proteins, will allow for the production of high-quality, high-protein carriers.

It is understood that the disclosed invention is not limited to the particular methodology, protocols and materials described as these can vary. It is also understood that the terminology used herein is for the purposes of describing particular embodiments only and is not intended to limit the scope of the present invention which will be limited only by the appended claims.

While the invention has been described in connection with specific embodiments thereof, the foregoing description has been given for clearness of understanding only and no unnecessary limitations should be understood therefrom. It will be understood that the description is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims. Those skilled in the art will recognize or be able to ascertain using no more than routine experimentation, many equivalents to the specific embodiments of the invention described herein. Such equivalents are intended to be encompassed by the following claims.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not, be taken as an acknowledgement or any form of suggestion that they constitute valid prior art or form part of the common general knowledge in any country in the world.

### NUMBERED EMBODIMENTS

Notwithstanding the appended claims, the disclosure sets forth the following numbered embodiments:

Embodiment 1. A carrier:filler food composition comprising:
(a) a carrier and a filler, wherein the amount of total protein provided by the carrier is greater than or equal to the amount of total protein provided by the filler;
(b) greater than 20% of total calories from protein per serving; and
(c) less than 640 total calories per serving.

Embodiment 1.1. The composition of embodiment 1, wherein the carrier and filler are present at a carrier:filler protein ratio between 1:1 to 1:0.

Embodiment 1.2. The composition of embodiment 1 or 1.1, wherein the carrier comprises microbially produced protein.

Embodiment 1.3. The composition of any one of embodiments 1, to 1.2, wherein the carrier comprises a mixture of plant protein and microbially produced protein.

Embodiment 1.4. The composition of any one of embodiments 1 to 1.3, wherein the carrier comprises at least 15% total protein by weight of microbially produced protein.

Embodiment 1.5. The composition of embodiment 1.4, wherein the microbially produced protein is obtained by fermentation of a biomass by a microbe.

Embodiment 1.6. The composition of embodiment 1.5, wherein the biomass is plant biomass.

Embodiment 1.7. The composition of embodiment 1.6, wherein the plant biomass is selected from the group consisting of a food crop, an extract of a food crop, seaweed, plankton, phytoplankton, grass crops, agricultural crop waste and residues, spent grain from ethanol production, or spent grain from breweries, spent yeast or microbial biomass from fermented products manufacturing facilities, trees, woody energy crops and wood waste and residue.

Embodiment 1.8. The composition of embodiment 1.7, wherein the food crop is selected from the group consisting of sugarcane, wheat, tubers, vegetables, lentils, kelp, legumes, soybeans, rice, potato, oats, pea, cassava and maize.

Embodiment 1.9. The composition of embodiment 1.7, wherein the agricultural crop waste and residue is selected from the group consisting of corn stover, wheat straw, rice straw and sugar cane bagasse.

Embodiment 1.10. The composition of any one of embodiments 1.5-1.9, wherein the microbe is selected from the group consisting of a fungus, a bacterium, an archaea, a protist and any combination thereof.

Embodiment 1.11. The composition of any one of embodiments 1.5-1.10, wherein the microbe is a fungus selected from the group consisting of a yeast or filamentous fungus.

Embodiment 1.12. The composition of embodiment 1.11, wherein the yeast is a Pichia species or Saccharomyces species.

Embodiment 1.13. The composition of embodiment 1.12, wherein the yeast is Saccharomyces cerevisiae.

Embodiment 1.14. The composition of embodiment 1.11, wherein the filamentous fungus is a species of filamentous fungus selected from the group consisting of Aspergillus, Fusarium, Rhizopus or Mucor.

Embodiment 1.15. The composition of embodiment 1.14, wherein the filamentous fungus is Aspergillus niger.

Embodiment 1.16. The composition of embodiment 1.10, wherein the microbe is a species of bacterium selected from the group consisting of Lactobacillus, Bacillus, Bifidobacterium, Clostridium, Enterococcus, Corynebacterium and any combination thereof.

Embodiment 1.17. The composition of embodiment 1.16, wherein the bacterium is Corynebacterium glutamicum.

Embodiment 1.18. The composition of embodiment 1.16, wherein the bacterium is Clostridium acetobutylicum.

Embodiment 2. The composition of embodiments 1 to 1.18, wherein the composition comprises between 20% to 51% of calories from protein and between 50 calories to 640 calories per serving.

Embodiment 3. The composition of any one of embodiments 1 to 2, wherein the composition comprises a minimum of 20% of calories coming from protein and between 120 calories to 640 calories per serving.

Embodiment 4. The composition of any one of embodiments 1 to 3, wherein the composition comprises a maximum of 51% of calories coming from protein and between 120 calories to 640 calories per serving.

Embodiment 5. The composition of any one of embodiments 1 to 4, wherein the composition comprises at least 40% to 220% more calories from protein compared to a generic composition.

Embodiment 6. The composition of any one of embodiments 1 to 5, wherein the composition comprises 20% to 70% fewer calories from carbohydrates compared to a generic composition.

Embodiment 7. The composition of any one of embodiments 1 to 6, wherein the composition comprises similar calories from fat while maintaining higher protein compared to a generic composition.

Embodiment 8. The composition of any one of embodiments 1 to 7, wherein the PDCAAS of the carrier is a value selected from the group consisting of at least 0.8, at least 0.9 and at least 1.0.

Embodiment 9. The composition of any one of embodiments 1 to 8, wherein the moisture content is between 2-80%.

Embodiment 10. The composition of any one of embodiments 1 to 9, wherein the caloric content of the composition is selected from the group consisting of less than 640 calories per serving, less than 500 calories per serving, and less than 400 calories per serving.

Embodiment 11. The composition of any one of embodiments 1 to 10, wherein the filler is not an animal product.

Embodiment 12. The composition of any one of embodiments 1 to 15, wherein the filler is selected from the group consisting of a vegan filler, a plant-based product, an animal product, both an animal product and a plant-based product, a water-in-oil based emulsion and an oil-in-water emulsion.

Embodiment 13. The composition of embodiment 12, wherein the plant-based product is selected from the group consisting of a vegetable, a fruit, a veggie patty and any combination thereof.

Embodiment 14. The composition of embodiment 13, wherein the vegetable is a potato.

Embodiment 15. The composition of embodiment 13, wherein the fruit is an avocado or cucumber.

Embodiment 16. The composition of embodiment 12, wherein the animal product is a hamburger or a cheese.

Embodiment 17. The composition of any one of embodiments 1 to 16, wherein the composition comprises at least one slice.

Embodiment 18 The composition of any one of embodiments 1 to 29, wherein the carrier has a thickness selected from the group consisting of at least 0.1 centimeter, at least 1 centimeter, at least 2 centimeters and at least 3 centimeters.

Embodiment 19. The composition of any one of embodiments 1 to 18, wherein the carrier comprises a single slice of bread.

Embodiment 20. The composition of any one of embodiments 1 to 19, wherein the carrier comprises two slices of bread.

Embodiment 21. The composition of any one of embodiments 1 to 20, wherein the carrier comprises a single slice of cracker.

Embodiment 22. The composition of any one of embodiments 1 to 21, wherein the carrier comprises two slices of cracker.

Embodiment 23. The composition of any one of embodiments 1 to 22, wherein the carrier comprises a single slice of sheeted dough.

Embodiment 24. The composition of any one of embodiments 1 to 23, wherein the carrier comprises two slices of sheeted dough.

Embodiment 25. A method of producing a carrier:filler food composition comprising:
a. providing a high-protein powder, a comestible, and a liquid,
b. mixing the high-protein powder, comestible, and liquid into a homogeneous composition,
c. leavening the homogeneous composition;
d. baking the homogeneous composition to produce a carrier; and,
d. disposing a filler with the carrier to generate a carrier:filler food composition,
wherein the amount of total protein provided by the carrier in the carrier:filler food composition is greater than or equal to the amount of total protein provided by the filler;
wherein the carrier:filler food composition comprises greater than 20% of total calories from protein per serving;
wherein the carrier:filler food composition comprises less than 640 total calories per serving.

Embodiment 25.1. The method of embodiment 25, wherein the carrier and filler are present at a carrier:filler protein ratio between 1:1 to 1:0.

Embodiment 25.2. The method of embodiment 25.1, wherein the carrier comprises microbially produced protein.

Embodiment 25.3. The method of any one of embodiments 25 to 25.2, wherein the carrier comprises at least 15% total protein by weight of microbially produced protein.

Embodiment 26. The method of any one of embodiments 25 to 25.3, wherein the composition comprises between 20% to 51% of calories from protein and between 50 calories to 640 calories per serving.

Embodiment 27. The method of any one of embodiments 25 to 26, wherein the composition comprises a minimum of 20% of calories coming from protein and between 120 calories to 640 calories per serving.

Embodiment 28. The method of any one of embodiments 25 to 27, wherein the composition comprises a maximum of 51% of calories coming from protein and between 120 calories to 640 calories per serving.

Embodiment 29. The method of any one of embodiments 25 to 28, wherein the composition comprises at least 40% to 220% more calories from protein compared to a generic composition.

Embodiment 30. The method of any one of embodiments 25 to 29, wherein the composition comprises 20% to 70% fewer calories from carbohydrates compared to a generic composition.

Embodiment 31. The method of any one of embodiments 25 to 30, wherein the composition comprises similar calories from fat while maintaining higher protein compared to a generic composition.

Embodiment 32. The method of any one of embodiments 25-31, wherein the PDCAAS of the carrier produced by baking the homogeneous composition is a value selected from the group consisting of at least 0.8, at least 0.9, and at least 1.0.

Embodiment 33. The method of any one of embodiments 25 to 32, wherein the calorie content of the carrier:filler food composition is selected from the group consisting of less than 640 calories per serving, less than 500 calories per serving, and less than 400 calories per serving.

Embodiment 34. The method of any one of embodiments 25-33, wherein the moisture content of the carrier:filler food composition is between 2-80%.

Embodiment 35. The method of any one of embodiments 40 to 34, wherein the filler is not an animal product.

Embodiment 36. The method of any one of embodiments 40 to 35, wherein the filler is selected from the group consisting of a vegan filler, a plant-based product, an animal product, both an animal product and a plant-based product, a water-in-oil based emulsion and an oil-in-water emulsion.

Embodiment 37. The composition of embodiment 36, wherein the plant-based product is selected from the group consisting of a vegetable, a fruit, a veggie patty and any combination thereof.

Embodiment 38. The composition of embodiment 37, wherein the vegetable is a potato.

Embodiment 39. The composition of embodiment 37, wherein the fruit is an avocado or cucumber.

Embodiment 40. The composition of embodiment 36, wherein the animal product is a hamburger or a cheese.

Embodiment 41. The method of any one of embodiments 25 to 40, wherein the composition comprises at least one slice.

Embodiment 42. The composition of any one of embodiments 25 to 41, wherein the carrier has a thickness of at least 0.1 centimeter.

Embodiment 43. The composition of any one of embodiments 25 to 42, wherein the carrier has a thickness of at least 1 centimeter.

Embodiment 44. The composition of any one of embodiments 25 to 43, wherein the carrier has a thickness of at least 2 centimeters.

Embodiment 45. The composition of any one of embodiments 25 to 44, wherein the carrier has a thickness of at least 3 centimeters.

Embodiment 46. The method of any one of embodiments 25 to 45, wherein the carrier comprises a single slice of bread.

Embodiment 47. The method of any one of embodiments 25 to 46, wherein the carrier comprises two slices of bread.

Embodiment 48. The method of any one of embodiments 25 to 47, wherein the carrier comprises a single slice of cracker.

Embodiment 49. The method of any one of embodiments 25 to 48, wherein the carrier comprises two slices of cracker.

Embodiment 50. The method of any one of embodiments 25 to 49, wherein the carrier comprises a single slice of sheeted dough.

Embodiment 51. The method of any one of embodiments 25 to 50, wherein the carrier comprises two slices of sheeted dough.

### PATENT CITATIONS

US20230281444A1, “System and Algorithm for in silico determination of protein quality”
U.S. Pat. No. 9,700,071B2, “Nutritive fragments, proteins, and methods”
US20040208962A1, “High protein peanut butter and jelly sandwich”
AU2004253169C1, “High protein, reduced-carbohydrate bakery and other food products”
U.S. Pat. No. 6,004,596, “Sealed crustless sandwich”
NZ585480A, “High fiber and high protein baked goods production”
CA2522212A1, “Frozen microwaveable bakery products”
RU2702089C1, “Bread of enhanced nutritive value and method for its production”

### NON-PATENT CITATIONS

Liao et al, “Muscle amelioration by yeast protein supplementation was associated with gut microbiota”, Journal of Functional Foods, February 2022
Rul et al, “Underlying evidence for the health benefits of fermented foods in Humans”, Food Funct. Vol 13, 2022
Johnston et al, “High-protein, Low-fat diets are effective for weight loss and favorably alter biomarkers in healthy adults”, The Journal of Nutrition, March 2004
Schaafsma G (July 2000). “The protein digestibility-corrected amino acid score”. The Journal of Nutrition. 130 (7): 1865S-7S. doi:10.1093/jn/130.7.1865S. PMID 10867064.)

1. A carrier:filler food composition comprising:
a. a carrier and a filler, wherein the amount of total protein provided by the carrier is greater than or equal to the amount of total protein provided by the filler;
b. greater than 20% of total calories from protein per serving; and
c. less than 640 total calories per serving.

2. The composition of claim 1, wherein the carrier and filler are present at a carrier:filler protein ratio between 1:1 to 1:0.

3. The composition of claim 1, wherein the carrier comprises microbially produced protein.

4. The composition of claim 3, wherein the carrier comprises at least 15% total protein by weight of microbially produced protein.

5. The composition of claim 1, wherein the composition comprises between 20% to 51% of calories from protein and between 50 calories to 640 calories per serving, a minimum of 20% of calories coming from protein and between 120 calories to 640 calories per serving or a maximum of 51% of calories coming from protein and between 120 calories to 640 calories per serving.

6.-7. (canceled)

8. The composition of claim 1, wherein the composition comprises at least 40% to 220% more calories from protein compared to a generic composition, 20% to 70% fewer calories from carbohydrates compared to a generic composition and/or similar calories from fat while maintaining higher protein compared to a generic composition.

9.-10. (canceled)

11. The composition of claim 1, wherein the PDCAAS of the carrier is a value selected from the group consisting of at least 0.8, at least 0.9 and at least 1.0.

12. (canceled)

13. The composition of claim 1, wherein the caloric content of the composition is selected from the group consisting of less than 640 calories per serving, less than 500 calories per serving, and less than 400 calories per serving.

14. (canceled)

15. The composition of claim 1, wherein the filler is selected from the group consisting of a vegan filler, a plant-based product, an animal product, both an animal product and a plant-based product, a water-in-oil based emulsion and an oil-in-water emulsion.

16.-19. (canceled)

20. The composition of claim 1, wherein the carrier comprises a single slice of bread or two slices of bread.

21. (canceled)

22. A method of producing a carrier:filler food composition comprising:
a. providing a high-protein powder, a comestible, and a liquid;
b. mixing the high-protein powder, comestible, and liquid into a homogeneous composition;
c. leavening the homogeneous composition;
d. baking the homogeneous composition to produce a carrier; and;
d. disposing a filler with the carrier to produce a carrier:filler food composition,
wherein the amount of total protein provided by the carrier in the carrier:filler food composition is greater than or equal to the amount of total protein provided by the filler;
wherein the carrier:filler food composition comprises greater than 20% of total calories from protein per serving;
wherein the carrier:filler food composition comprises less than 640 total calories per serving.

23. The method of claim 22, wherein the carrier and filler are present at a carrier:filler protein ratio between 1:1 to 1:0.

24. The method of claim 22, wherein the carrier comprises microbially produced protein.

25. The method of claim 24, wherein the carrier comprises at least 15% total protein by weight of microbially produced protein.

26. The method of claim 22, wherein the composition comprises between 20% to 51% of calories from protein and between 50 calories to 640 calories per serving, a minimum of 20% of calories coming from protein and between 120 calories to 640 calories per serving or a maximum of 51% of calories coming from protein and between 120 calories to 640 calories per serving.

27.-28. (canceled)

29. The method of claim 22, wherein the composition comprises at least 40% to 220% more calories from protein compared to a generic composition, 20% to 70% fewer calories from carbohydrates compared to a generic composition and/or similar calories from fat while maintaining higher protein compared to a generic composition.

30.-31. (canceled)

32. The method of claim 22, wherein the PDCAAS of the carrier produced by baking the homogeneous composition is a value selected from the group consisting of at least 0.8, at least 0.9, and at least 1.0.

33. The method of claim 22, wherein the calorie content of the carrier:filler food composition is selected from the group consisting of less than 640 calories per serving, less than 500 calories per serving, and less than 400 calories per serving.

34. (canceled)

35. The method of claim 22, wherein the filler is selected from the group consisting of a vegan filler, a plant-based product, an animal product, both an animal product and a plant-based product, a water-in-oil based emulsion and an oil-in-water emulsion.

36.-40. (canceled)

41. The method of claim 22, wherein the carrier comprises a single slice of bread or two slices of bread.

42. (canceled)
